(19) United States
(12) Patent Application Publication
(10) Pub. No.: US 2022/0324421 A1
(43) Pub. Date: Oct. 13, 2022

(54) SYSTEMS AND METHODS FOR TERRAIN-BASED INSIGHTS FOR ADVANCED DRIVER ASSISTANCE SYSTEMS

(71) Applicant: ClearMotion, Inc., Billerica, MA (US)

(72) Inventors: Marco Giovanardi, Melrose, MA (US); Hou-Yi Lin, Cambridge, MA (US); Jack A. Ekchian, Belmont, MA (US)

(73) Assignee: ClearMotion, Inc., Billerica, MA (US)

(21) Appl. No.: 17/560,794

(22) Filed: Dec. 23, 2021

Related U.S. Application Data
(60) Provisional application No. 63/132,184, filed on Dec. 30, 2020.
(60) Provisional application No. 63/130,028, filed on Dec. 23, 2020.

(51) Int. Cl. B60T 7/22; B60W 10/18; B60W 30/09; B60W 30/16; B60W 40/06; B60W 50/16

(52) U.S. Cl. CPC B60T 7/22; B60W 10/18; B60W 30/09; B60W 30/16; B60W 40/06; B60W 50/16; B60T 2201/022; B60T 2210/10; B60T 2210/30; B60W 2050/143

(57) ABSTRACT

The systems and methods described herein are related to terrain-based insights for advanced driver assistance systems (ADAS) in vehicles. Such terrain-based insights may be related to ADAS features such as adaptive cruise control, lane keep assist, automatic emergency braking, collision avoidance, and/or speed adaptation, among others.

### RELATED APPLICATIONS

This application claims the benefit of priority under 35 U.S.C. § 119(e) of U.S. Provisional Application Ser. No. 63/130,028, filed Dec. 23, 2020, and U.S. Provisional Application Ser. No. 63/132,184, filed Dec. 30, 2020, the disclosures of which are incorporated herein by reference in their entirety.

### TECHNICAL FIELD

Disclosed embodiments are related to systems for terrain-based insights for advanced driver assistance systems in vehicles and related methods of use.

### BACKGROUND

Advanced vehicle features such as, for example, advanced driver assistance systems, active suspension systems, and/or autonomous or semi-autonomous driving may rely on highly accurate localization of a vehicle. Localization systems based on, for example, global navigation satellite systems (GNSS), may not provide sufficient accuracy or resolution for such features.

### SUMMARY

According to one aspect, the present disclosure provides a method for providing terrain-based insights to a terrain-based advanced driver assistance system of a vehicle. The method includes obtaining a road profile of a road segment the vehicle is traveling on, determining a location of the vehicle based at least partly on the road profile, and determining one or more operating parameters of one or more vehicle systems based at least partially on the location of the vehicle.

In some implementations, the method also includes transmitting the one or more operating parameters to the vehicle. In some instances, the method further includes operating the one or more vehicle systems based at least partly on the one or more operating parameters. In some instances, the method further includes operating the advanced driver assistance system based at least partly on the one or more operating parameters. In some instances, operating the advanced driver assistance system includes initiating an alert to a driver of the vehicle. In some instances, the alert includes at least one of a visual, audible, haptic, or tactile alert. In some instances, operating the advanced driver assistance system includes initiating an alert to an autonomous or a semi-autonomous driving controller of the vehicle.

According to another aspect, the present disclosure provides a method for providing terrain-based insights to an intelligent speed adaptation system of a vehicle. The method includes obtaining a road profile of a road segment the vehicle is traveling on, determining a location of the vehicle based at least partly on the road profile, and determining one or more recommended driving speeds based at least partly on the location of the vehicle.

In some implementations, the method also includes transmitting the one or more recommended driving speeds to the vehicle. In some instances, the method also includes operating the intelligent speed adaptation system based at least partly on the one or more recommended driving speeds. In some instances, operating the intelligent speed adaptation system includes initiating an alert to a driver of the vehicle. In some instances, the alert includes at least one of a visual, audible, haptic, or tactile alert. In some instances, the alert is a visual alert and is presented on a display in the vehicle. In some instances, operating the intelligent speed adaptation system includes initiating an alert to an autonomous or a semi-autonomous driving controller of the vehicle.

In some implementations, the recommended driving speed is based, at least partially, on road information for an upcoming portion of the road segment on which the vehicle is traveling. In some instances, road information for an upcoming portion of the road segment comprises weather information. In some instances, the weather information comprises an ambient temperature at the location of the vehicle. In some instances, the weather information comprises precipitation information at the location of the vehicle. In some instances, the weather information comprises fog information at the location of the vehicle.

In some implementations, the road profile information comprises at least one of road slope information, road roughness information, road frequency content, road friction information, road curvature, or road grip information.

In some implementations, road information for an upcoming portion of the road segment comprises road event information. In some instances, the road event information comprises a location of at least one of a pothole or a speedbump. In some instances, the road event information is based on road data that has been normalized by vehicle class.

In some implementations, road information for an upcoming portion of the road segment comprises road feature information, wherein the road feature is a bridge.

In some implementations, wherein the recommended driving speed is based, at least partially, on an average driving speed at which vehicles traverse the road segment.

According to another aspect, the present disclosure provides a method for providing a recommended driving speed to a vehicle. The method includes obtaining, by one or more sensors of the vehicle, road data of a road segment on which the vehicle is traveling, determining, based on the road data, a current road profile of the road segment, sending, to a cloud database, the current road profile, receiving, from the cloud database, a set of candidate stored road profiles, determining, by a processor, a location of the vehicle based on the set of candidate stored road profiles and the current road profile, determining, by the processor, a recommended driving speed, the recommended driving speed being based, at least partially, on the location of the vehicle, and initiating, via an advanced driver assistance system of the vehicle, an alert to a driver to change a driving speed of the vehicle.

In some implementations, the alert includes at least one of a visual alert, an audio alert, or a tactile alert. In some instances, the alert is a visual alert and is presented on a display in the vehicle.

In some implementations, the recommended driving speed is based, at least partially, on road information for an upcoming portion of the road segment on which the vehicle is traveling. In some instances, road information for an upcoming portion of the road segment includes weather information. In some instances, road information for an upcoming portion of the road segment comprises road profile information. In some instances, the road profile information includes at least one of road slope information, road roughness information, road frequency content, road friction information, road curvature, or road grip information. In some instances, road information for an upcoming portion of the road segment includes road event information. In some instances, road event information includes a location of at least one of a pothole or a speedbump. In some instances, the road event information is based on road data that has been normalized by vehicle class. In some instances, road information for an upcoming portion of the road segment comprises road feature information, wherein the road feature is a bridge.

In some implementations, the recommended driving speed is based, at least partially, on an average driving speed at which vehicles traverse the road segment.

According to another aspect, the present disclosure provides a method for providing terrain-based insights to an automatic emergency braking system of a vehicle. The method includes obtaining a road profile of a road segment the vehicle is traveling on, determining a location of the vehicle based at least partly on the road profile, and determining one or more automatic emergency braking trigger point distances at least partly on the location of the vehicle.

In some implementations, the method also includes transmitting the one or more automatic emergency braking trigger point distances to the vehicle. In some instances, the method also includes operating the automatic emergency braking system based at least partly on the one or more transmitted automatic emergency braking trigger point distances.

According to another aspect, the present disclosure provides a method for determining an automatic emergency braking trigger point distance for a vehicle. The method includes obtaining, by one or more sensors of the vehicle, road data of a road segment on which the vehicle is traveling, determining, based on the road data, a current road profile of the road segment, sending, to a cloud database, the current road profile, receiving, from the cloud database, a set of candidate stored road profiles, determining, by a processor, a location of the vehicle based on the set of candidate stored road profiles and the current road profile, determining, by the processor, the automatic emergency braking trigger point distance, the automatic emergency braking trigger point distance being based, at least partially, on the location of the vehicle, and initiating, when the vehicle is within the automatic emergency braking trigger point distance from another vehicle or object, via an advanced driver assistance system of the vehicle, an alert to a driver to brake.

In some implementations, the method also includes initiating, when the vehicle is within the automatic emergency braking trigger point distance, via an advanced driver assistance system of the vehicle, a braking command configured to initiate braking of the vehicle.

In some implementations, the method also includes initiating, when the vehicle is within a second distance, smaller than the automatic emergency braking trigger point distance, via an advanced driver assistance system of the vehicle, a braking command configured to initiate braking of the vehicle.

In some implementations, the alert includes at least one of a visual alert, an audio alert, or a tactile alert. In some instances, the alert is a visual alert and is presented on a display in the vehicle. In some instances, the automatic emergency braking trigger point distance is based, at least partially, on road information for an upcoming portion of the road segment on which the vehicle is traveling. In some instances, road information for an upcoming portion of the road segment includes weather information. In some instances, road information for an upcoming portion of the road segment includes road profile information. In some instances, the road profile information includes at least one of road slope information, road roughness information, road frequency content, road friction information, road curvature, or road grip information. In some instances, road information for an upcoming portion of the road segment includes road event information. In some instances, road event information includes a location of at least one of a pothole or a speedbump. In some instances, the road event information is based on road data that has been normalized by vehicle class. In some instances, road information for an upcoming portion of the road segment includes road feature information, wherein the road feature is a bridge.

According to another aspect, the present disclosure provides a method for providing terrain-based insights to an adaptive cruise control system of a vehicle. The method includes obtaining a road profile of a road segment the vehicle is traveling on, determining a location of the vehicle based at least partly on the road profile, and determining one or more following distances at least partly on the location of the vehicle.

In some implementations, the method also includes transmitting the one or more following distances to the vehicle.

In some implementations, the method also includes operating the adaptive cruise control system based at least partly on the one or more transmitted following distances.

According to another aspect, the present disclosure provides a method for determining a following distance for an adaptive cruise control system of a vehicle. The method includes obtaining, by one or more sensors of the vehicle, road data of a road segment on which the vehicle is traveling, determining, based on the road data, a current road profile of the road segment, sending, to a cloud database, the current road profile, receiving, from the cloud database, a set of candidate stored road profiles, determining, by a processor, a location of the vehicle based on the set of candidate stored road profiles and the current road profile, and determining, by the processor, the following distance, the following distance being based, at least partially, on the location of the vehicle.

In some implementations, the method also includes initiating, when the vehicle is within the following distance, a braking command configured to initiate braking of the vehicle.

In some implementations, the method also includes initiating, when the vehicle is within the following distance, a command configured to adjust a set speed of the adaptive cruise control.

In some implementations, the method also includes initiating an alert to a driver of a vehicle, wherein the alert comprises at least one of a visual alert, an audio alert, or a tactile alert. In some instances, the alert is a visual alert and is presented on a display in the vehicle.

In some implementations, the following distance is based, at least partially, on road information for an upcoming portion of the road segment on which the vehicle is traveling. In some instances, road information for an upcoming portion of the road segment includes weather information. In some instances, road information for an upcoming portion of the road segment includes road profile information. In some instances, the road profile information includes at least one of road slope information, road roughness information, road frequency content, road friction information, road curvature, or road grip information. In some instances, road information for an upcoming portion of the road segment includes road event information. In some instances, road event information includes a location of at least one of a pothole or a speedbump. In some instances, the road event information is based on road data that has been normalized by vehicle class. In some instances, road information for an upcoming portion of the road segment includes road feature information, wherein the road feature is a bridge.

According to another aspect, the present disclosure provides a method of adjusting an operating mode of a vehicle. The method includes obtaining, by one or more sensors of the vehicle, road data of a road segment on which the vehicle is traveling, determining, based on the road data, a current road profile of the road segment, sending, to a cloud database, the current road profile, receiving, from the cloud database, a set of candidate stored road profiles and other road information, determining, by a processor, a location of the vehicle based on the set of candidate stored road profiles and the current road profile, determining, by the processor, that a bridge exists on an upcoming portion of the road segment, determining, by the processor, that a slippery condition may be occurring on the upcoming portion of the road segment on the bridge, and determining, by the processor, a value of an operating parameter of the vehicle for traversing the bridge.

In some implementations, the operating parameter of the vehicle is at least one of a driving speed of the vehicle, a following distance of an adaptive cruise control of the vehicle, or an automatic emergency braking trigger distance.

In some implementations, the other road information comprises an ambient temperature at the location of the bridge.

In some implementations, the other road information comprises weather information at the location of the bridge. In some instances, the weather information includes precipitation information at the location of the bridge.

According to another aspect, the present disclosure provides a method for calculating a target travel path for a first vehicle traversing a road segment. The method includes determining a current location of a first vehicle, obtaining a target travel path for traversing the road segment based at least in part on the current location of the first vehicle, and determining an error between the current location of the first vehicle and the target travel path.

In some implementations, the method also includes operating one or more vehicle systems based at least in part on the determined error. In some instances, the one or more vehicle systems includes an autonomous driving trajectory planning system. In some instances, the one or more vehicle systems includes a lane keep assist system.

In some implementations, the method also includes comparing the error to a threshold and determining that a current path of the first vehicle is appropriate for traversing the road segment.

In some implementations, the method also includes comparing the error to a threshold and determining that a current path of the first vehicle is inappropriate for traversing the road segment. In some instances, the method also includes calculating, based on the error, a corrective action to bring the current trajectory to match the target travel path. In some instances, the method also includes initiating the corrective action with an advanced driver assistance system of the first vehicle that at least partially influences the steering of the first vehicle. In some instances, calculating the target travel path includes averaging at least one other path taken by the at least one other vehicle across the road segment.

According to another aspect, the present disclosure provides a steering correction system for a vehicle. The steering correction system includes a localization system configured to determine a location of the vehicle, at least one system configured to influence a direction of travel of the vehicle, and a processor configured to perform the steps of: obtaining the location of the vehicle from the localization system; obtaining a target path of travel based at least partly on the location of the vehicle; determining a current path of travel of the vehicle; and controlling the at least one system based at least partly on the target path of travel and the current path of travel.

In some implementations, the at least one system configured to influence the direction of vehicle travel is at least one rear steering actuator. In some instances, the localization system is a localization system having an accuracy within 0.3 meters. In some instances, the localization system uses global navigation satellite systems enhanced through real-time kinematic positioning. In some instances, the localization system uses inertial navigation enhanced by global navigation satellite systems. In some instances, the processor is further configured to perform the step of initiating transmission of the location of the vehicle to a cloud computing system. In some instances, the processor is further configured to perform the step of receiving the target path of the vehicle from a cloud computing system.

According to another aspect, the present disclosure provides a method of providing steering correction commands to a vehicle system. The method includes obtaining travel paths from at least two vehicles using high-accuracy localization, generating an aggregate path from the travel paths of the at least two vehicles, wherein the aggregate path is representative of one lane in a road, obtaining a current travel path of an operated vehicle obtained using a high-accuracy localization system, comparing the current travel path with the aggregate path, generating a corrective command to correct the current travel path of the vehicle in motion, and sending the corrective steering command to a steering controller.

In some implementations, during the generating of the aggregate path, the input travel paths are filtered to remove outliers and undesirable travel paths. In some instances, the travel paths from at least two vehicles are obtained using global navigation satellite systems enhanced through real-time kinematic positioning. In some instances, the travel paths from at least two vehicles are obtained using inertial navigation enhanced by global navigation satellite systems. In some instances, the current travel path is obtained using global navigation satellite systems enhanced through real-time kinematic positioning. In some instances, the current travel path is obtained using inertial navigation enhanced by global navigation satellite systems.

According to another aspect, the present disclosure provides a vehicle including a localization system configured to determine a location of the vehicle, a display, and a processor configured to perform the steps of: obtaining a location of the vehicle from the localization system; determining the presence of one or more road surface features on a road surface based at least in part on the location of the vehicle; and presenting on the display a position of the one or more road surface features on the road surface.

In some implementations, the position is determined at least partially based on road surface information downloaded from a cloud-based database.

In some implementations, the display is selected from the group consisting of a heads-up display and a monitor.

In some implementations, the controller is further configured to present, on the display, a projected tire path of at least one tire of the vehicle relative to the one or more road surface features.

In some implementations, the controller is further configured to present, on the display, a projected tire path of two front tires of the vehicle.

In some implementations, the one or more road surface features includes a pothole or a bump.

According to another aspect, the present disclosure provides a method of operating a vehicle. The method includes (a) while a vehicle is traveling along a road surface, determining a location of a road surface feature on the road surface the location of the road surface feature being relative to the vehicle, and (b) presenting, on a display, the location of the road surface feature on the road surface.

In some implementations, presenting the location of the road surface feature includes presenting a graphical representation of the road surface feature on the display.

In some implementations, the display is a heads-up display.

In some implementations, the method also includes presenting, on the display a projected tire path of at least one tire of the vehicle. In some instances, the method also includes, based on the projected tire path of the at least one tire of the vehicle, adjusting a steering angle of a steering wheel of the vehicle to avoid the road surface feature.

In some implementations, the road surface feature is a pothole.

According to another aspect, the present disclosure provides a method of operating a vehicle under conditions of poor visibility. The method includes (a) while the vehicle is traveling along a road surface, determining, using at least one remote sensor, a location, relative to the road surface, of at least one other vehicle, and (b) presenting, on a display, the determined location of the at least one other vehicle (a) relative to an image of the road surface.

In some implementations, the conditions of poor visibility are caused by fog and the at least one remote sensor is a radar detector.

In some implementations, the display is a heads-up display or a monitor.

In some implementations, presenting, on the display, the determined location of the at least one other vehicle includes presenting a graphical representation of the at least one other vehicle on the display.

According to another aspect, the present disclosure provides a method for providing terrain-based insights to an adaptive headlight system of a vehicle. The method includes obtaining road surface information of a road segment the vehicle is traveling on, determining a location of the vehicle based at least partly on the road surface information, and determining one or more target illumination areas based at least partly on the location of the vehicle.

In some implementations, the method also includes transmitting the one or more target illumination areas to the vehicle. In some instances, the method also includes operating the adaptive headlight system based at least partly on the one or more transmitted target illumination areas.

In some implementations, the road surface information comprises a road profile.

According to another aspect, the present disclosure provides a method for providing terrain-based insights to an adaptive ADAS sensor system of a vehicle. The method includes obtaining road surface information of a road segment the vehicle is traveling on, determining a location of the vehicle based at least partly on the road surface information, and determining one or more target sensing areas based at least partly on the location of the vehicle.

In some implementations, the method also includes transmitting the one or more target sensing areas to the vehicle. In some instances, the method also includes operating the adaptive headlight system based at least partly on the one or more transmitted target sensing areas.

In some implementations, wherein the road surface information includes a road profile.

Intelligent Speed Adaptation systems warn or enforce driving speed based on a speed limit and/or upcoming road information. The Inventors have recognized that driving speed recommendations for safety, comfort, and/or vehicle durability may be determined with foresight of one or more upcoming road conditions. Upcoming road conditions may include, but are not limited to, road events, road roughness, road frequency content, road friction, road curvature, weather dependent events, and/or average driving speed. With precise localization and data sharing with a database, a recommended driving speed, which may be based on foresight of upcoming road conditions, may be calculated, and served to an Intelligent Speed Adaptation system on vehicle. The Intelligent Speed Adaptation system then may warn and/or enforce the recommended driving speed to a driver of the vehicle to improve safety, comfort, fuel economy, range, and/or vehicle durability, or other desired metrics.

Advanced driver assistance systems (ADAS) in today's vehicles enhance the driver's ability to steer the vehicle to remain within a lane and avoid encroaching on adjacent lanes of travel on roadways. This safety feature commonly relies on vision-based sensor systems like forward-and sideways-facing cameras to identify lane markers and determine an appropriate path to take within the lane.

The sensor systems used for this application are vulnerable to multiple potential failures, including sensor obscurement through reflections or dirt on the glass; sensor function reduction due to environmental conditions such as rain, fog, snow; and a possible general inability to identify lane markers, for example due to lighting problems such as darkness.

The inventors have recognized that using additional inputs may enhance the function of such lane assistance systems. In one implementation, a high-definition map is used, containing details related to the road such as for example the terrain profile, road events, road content, and/or similar road characterization features; road signs and other distinctive landmarks in the vehicle's surroundings; mean, median, and/or typical heading; curvature, and/or path of previous drives; or any subset thereof, in addition to many other possible details. In one embodiment, this map may be crowd-sourced by gathering data from other vehicles and/or from previous drives. Next, an accurate estimate of the vehicle's current position may be made, for example using terrain-matching of road features or events from the high-definition map or using feature matching for landmarks in the road profile or the environment, or using high precision global navigation system signals. Once an accurate location is known, and given the typical path driven by other vehicles, this information may be used to determine any undesired deviations from the path by the current vehicle. These deviations may be used as an additional input for the driver assistance feature, for example as a redundant sensor to confirm validity of the planned path, as a fallback sensor to bridge sections of road with insufficient markings (such as for example at intersections where the lane markings on one side of the road are discontinued), or as additional input into a sensor fusion to determine the vehicle's position and planned path. The input provided by this system has a much longer time horizon than the visual systems typically used and may thus serve as a low frequency correction signal.

An advanced driver assist feature or autonomous driving trajectory planning system may steer or aid the operator in steering a vehicle along a path. This safety feature commonly relies on vision-based sensor systems like forward and sideways-facing cameras, or distance- or range-based sensor systems like LiDAR or Radar, to identify lane markers and determine an appropriate path to take in order to remain within the travel lane.

Sensor systems used for this application may be vulnerable to multiple potential failures, for example where lane markings are obstructed, obscured, or not present for short stretches of road, and may lead to an incorrect trajectory being commanded by the assist feature or autonomous driving planner.

The inventors have recognized that by using precise localization and one or more trajectory paths from previous drives to provide an added error signal to the path planning controller or to the human operator, the impact of sensor failure on providing driver assistance may be decreased.

This compensation for sensor failures may be done, for example by using information based on previous drives in the same vehicle along the desired path or based on previous drives in at least one different vehicle along the desired path. This information may for example be the location of the vehicle in combination with a heading of each vehicle. In combination with accurate localization along the path, this information may be used to generate a reference trajectory or heading for each road segment.

As the vehicle traverses a path for which a reference trajectory or heading is known, and provided the vehicle is equipped with an accurate localization system and a connection to a database containing the reference trajectory information, which may be stored locally in the vehicle, or stored in the cloud and downloaded to the vehicle through an over-the-air connection at appropriate intervals, a reference path ahead of the vehicle may be provided.

Comparing this reference path to the trajectory determined by the vision-based system allows for fault detection and for a correction or a disengagement of the system if the trajectory is determined to be incorrect or not trustworthy, thus reducing the potential for causing harm to the vehicle, its occupants, or others in the vicinity.

Modern road vehicles have headlights configured to illuminate the road ahead of the vehicle. It is generally true that illuminating the road farther ahead of the vehicle is more beneficial, provided that the light source (i.e., the headlamps) is sufficiently strong. Illuminating the road far ahead of the vehicle though may also have a negative impact, because the headlights will then also shine strong light onto oncoming vehicles, potentially obstructing the visibility of operators of such vehicles. For this reason, maximum allowed headlight angles are generally regulated by authorities such as local departments of motor vehicles. Another problem occurs when a vehicle is rounding a turn and the headlights are illuminating the section of road straight ahead of the vehicle and not the section of road which the vehicle is about to traverse.

Some vehicle makers have begun using headlights with the ability to change the angle of their light beam from left to right and/or up and down. This may be done in multiple ways, for example including using an actuator system to move the headlight, headlight assembly, lenses, or reflectors that direct the light beam, or by using a plurality of light sources, each illuminating at least partially toward a different direction and engaging them selectively as desired. The selection of the desired angle may be guided at least in part by looking at the projected trajectory of the vehicle, or by using a predicted path based on map data, or by sensors that detect road path changes, for example cameras or lidar systems. The selection may also be at least partially guided by sensors that indirectly or directly measure the position of the vehicle with respect to the road.

When driving on a road with significant elevation change, the headlights are only illuminating parts of the road ahead of the vehicle. For example, when driving on a road that rises in front of the vehicle, the headlights illuminate a section of road that is closer to the vehicle and potentially smaller than if the road were flat. When driving on a road that falls away in front of the vehicle, the headlights illuminate a section of road that is farther in front of the vehicle and potentially larger, but also potentially illuminating oncoming vehicles in an undesired manner. Even using headlight systems described above, this problem cannot be solved, as the road ahead of the vehicle is not known and can, generally, not be sufficiently sensed with existing sensor systems such as vision-based systems, LiDAR, radar, or other known technologies.

The inventors have recognized that terrain-based advanced driver assistance systems (terrain-based ADAS) may take advantage of a known road profile ahead of the vehicle, for example including the road elevation change and/or the road curvature. Using a method to supply this information to the vehicle with enough advance notice, a vehicle controller may decide to request an actuation of the headlight mechanism, or a change in the headlight illumination pattern, with sufficient advanced notice to compensate for dynamics of the actuation, the upcoming path of the road, and the presence or absence of oncoming traffic.

The method described above for adjusting headlight beams may be used to modify the function of ADAS sensors in the vehicle, such as for example LiDAR, radar, or light-based sensors such as cameras, to account for upcoming road obstacles or road contour. If an ADAS sensor has a mechanism for adjusting its lateral and/or vertical directionality and/or sensitivity and/or range, or has other methods of modifying its optimal functionality, such as for example adjusting its focus range or the amount of background lighting or other parameters, then in a manner similar to what was described above, the optimal parameters may be adjusted based on upcoming road contour.

For example, in one embodiment, a LiDAR sensor may be able to detect objects at a distance and be calibrated for a vehicle on a level road and may have an actuation mechanism for adjusting its lateral and/or vertical directionality and/or sensitivity, or it may have a mechanism for adjusting its range based on internal settings. In the presence of a road feature such as a hill cresting or a bowl, the angle may be adjusted pre-emptively to correctly identify the features more relevant for the vehicle. On the other hand, understanding the road contour ahead of the vehicle may also be used to provide information to the operator or driving system that the sensor's detection range is expected to be lower, for example, due to road features ahead of the car, and that thus the vehicle speed or other settings (e.g., driving controller settings) may need to be adjusted.

Advanced driver assistance systems (ADAS) may use onboard sensors to provide steering corrections to a vehicle. This steering correction is often suggested to an operator through tactile feedback and/or performed by front steering actuators; however, this feedback may be intrusive or perceived by the driver as an uncomfortable pulling of the vehicle to one side or another. Systems and methods described herein may detect lane position by collecting driving data from numerous vehicle paths and creating an aggregate path and provide unintrusive steering correction based on the difference between the vehicle's current path and the aggregate path, using rear steering actuators. Localization methods may be used to determine a vehicle path within a travel lane. If the vehicle path diverges from the aggregate path, the system may create a command for a steering correction system, the steering correction system including one or more rear steering actuators, to influence the travel direction of the vehicle.

In some implementations, a vehicle may include a display unit, and a controller that is configured to display, on the display unit, a position of a road-surface feature, where the position is determined at least partially based on road-surface information downloaded from a cloud-based database. The display unit may be, for example, a heads-up display or a monitor. In some embodiments, the controller may be configured to also display the projected tire path of at least one tire of the vehicle relative to road surface feature. The controller may also be configured to display the projected tire path of the two front tires of the vehicle. The feature may be, for example, a pothole or a bump.

According to another aspect, the disclosure provides a method for operating a vehicle, where the method includes, determining a location, relative to the road surface, of a road-surface feature while a vehicle is traveling along the road surface. The method may further include displaying, on a display unit, an image of the road surface and an image of the road-surface feature at the determined location, relative to the road surface. In some implementations, display unit may be for example a heads-up display or a monitor. In addition, a projected tire path, of at least one tire of the vehicle, may also be shown relative to the road-surface feature. The method may further include adjusting the steering angle of a steering wheel of the vehicle to avoid the road-surface feature. This adjustment may be based on the projected tire path of at least one tire of the vehicle relative to the road-surface feature. In some implementations the feature may be a pothole or a bump.

According to another aspect, the disclosure provides a method for operating a vehicle under conditions of poor visibility. The method may further include using at least one remote sensor to determine a location, relative to the road, of at least one other vehicle, while the vehicle is traveling along a road. The method may further include displaying, on a display unit, an image of the other vehicle at the determined location relative to an image of the road. In some implementations, the poor visibility may be caused by fog and the at least one remote sensor may be a radar detector.

### BRIEF DESCRIPTION

The accompanying drawings are not intended to be drawn to scale. In the drawings, each identical or nearly identical component that is illustrated in the various figures may be represented by a like numeral. For purposes of clarity, not every component may be labeled in every drawing. In the drawings:

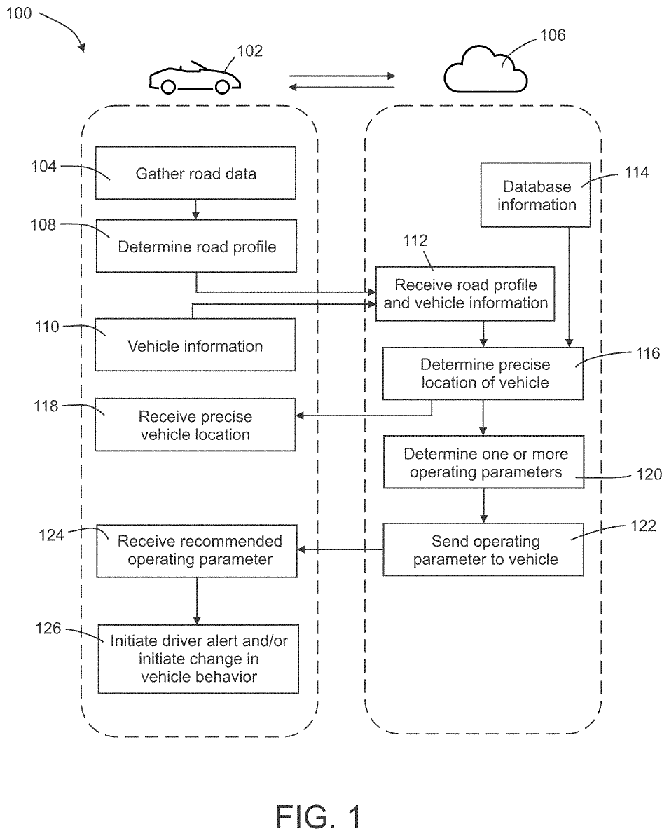

FIG. 1 is a schematic of a terrain-based advanced driver assistance system configured to alert a driver of a vehicle and/or change one or more aspects of vehicle behavior.

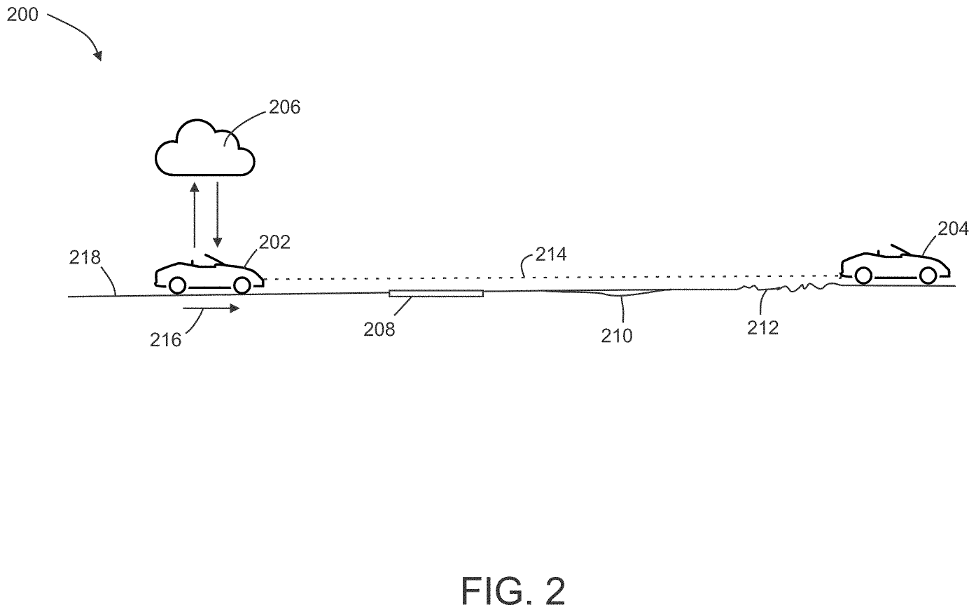

FIG. 2 shows a vehicle equipped with a terrain-based advanced driver assistance system traversing a road segment including a plurality of road events such as ice, a puddle, and an area of high amplitude input content.

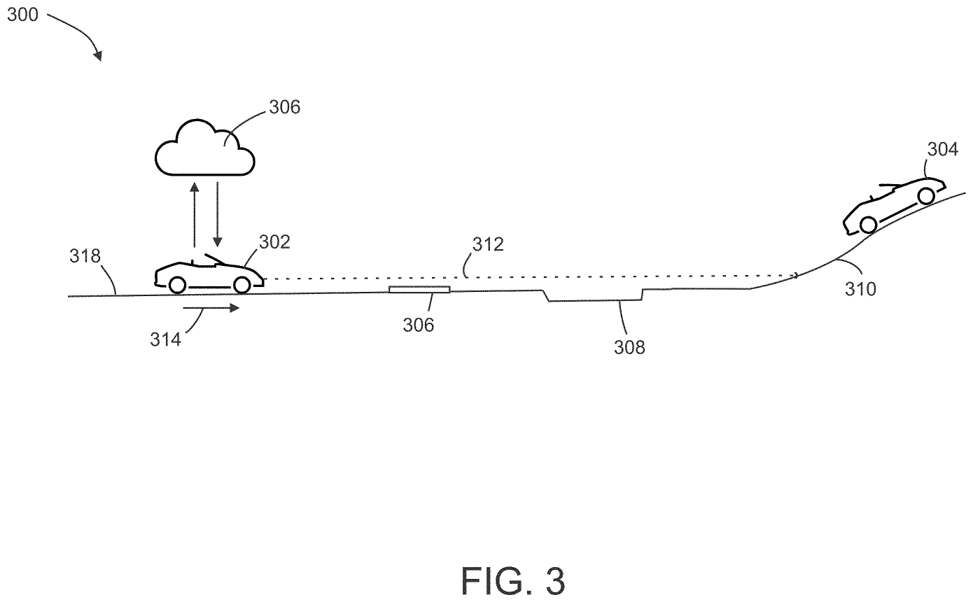

FIG. 3 shows a vehicle equipped with a terrain-based advanced driver assistance system traversing a road segment including a plurality of road events including a speed bump, a pothole, and a change in elevation.

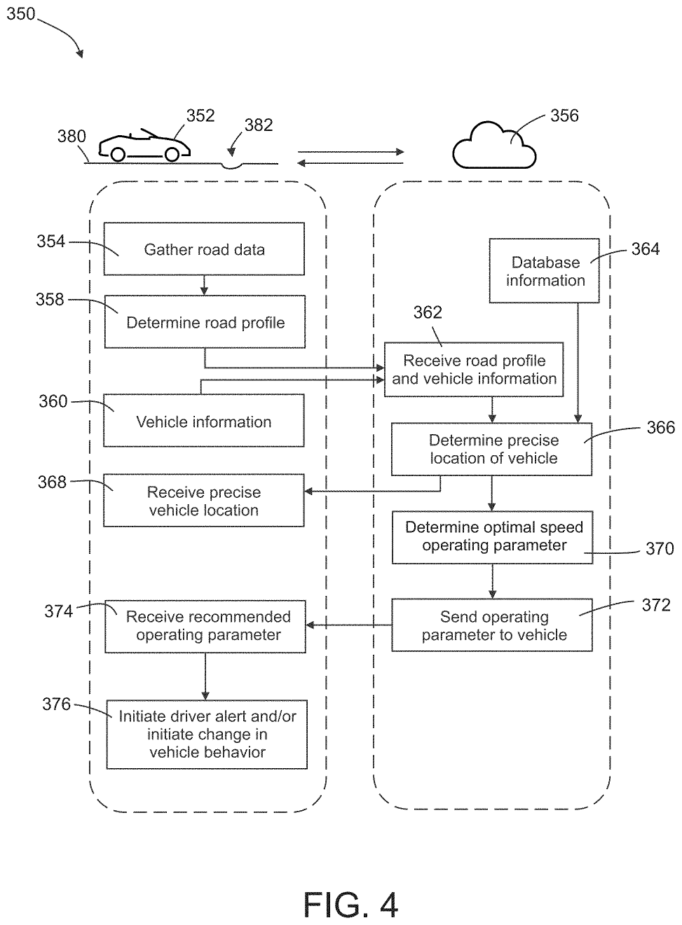

FIG. 4 is a flowchart showing a system and method for determining an optimal speed operating parameter for a vehicle.

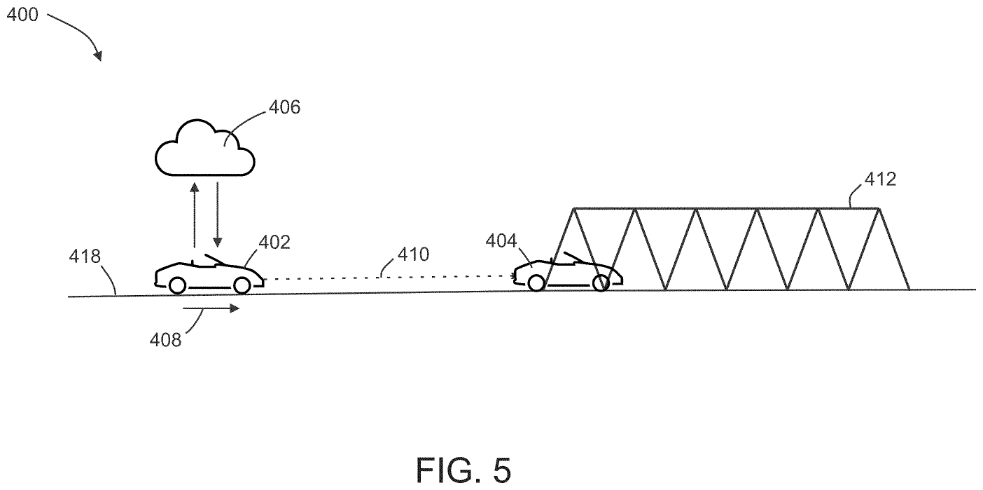

FIG. 5 shows a vehicle equipped with a terrain-based advanced driver assistance system traversing a road segment including a bridge.

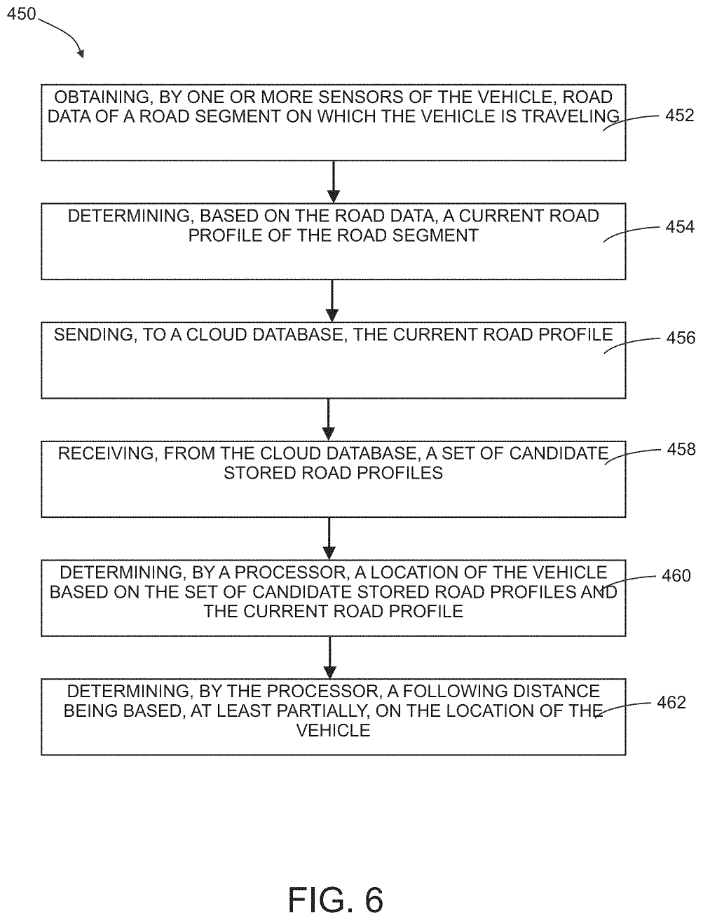

FIG. 6 is a flowchart showing a method for determining a following distance for an adaptive cruise control system of a vehicle.

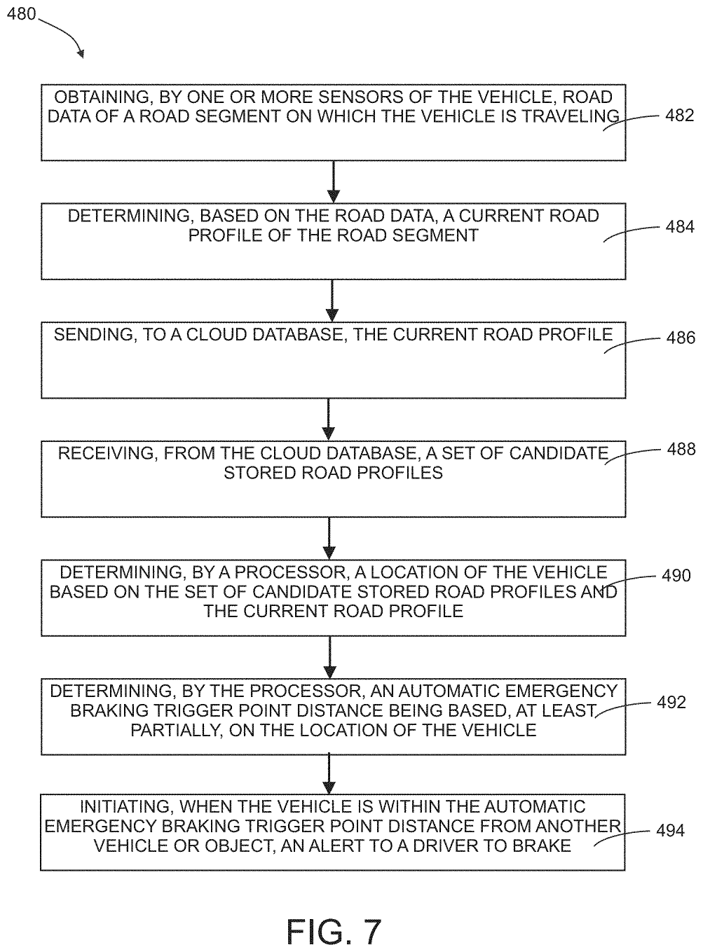

FIG. 7 is a flowchart showing a method for determining a braking trigger distance for an automatic emergency braking system of a vehicle.

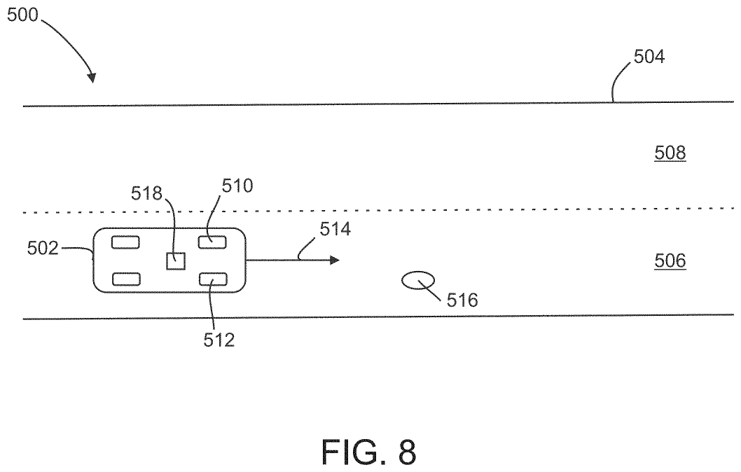

FIG. 8 shows a vehicle equipped with a terrain-based advanced driver assistance system traveling on a road segment and approaching a road event, e.g., a pothole.

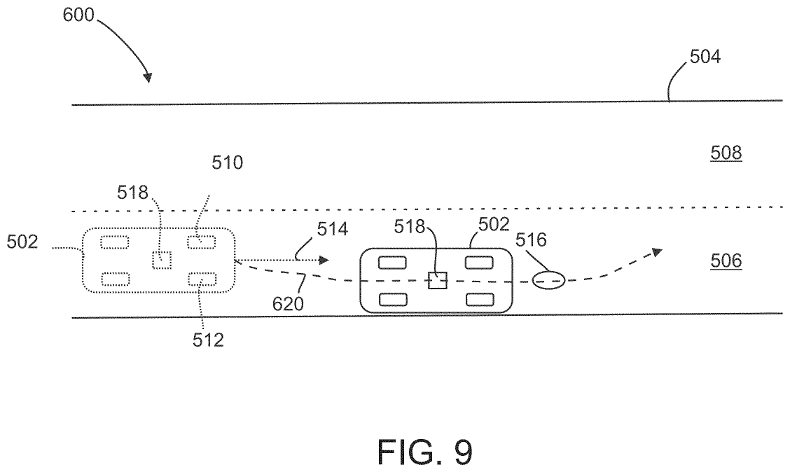

FIG. 9 shows the vehicle of FIG. 8 performing an intra-lane event avoidance behavior to straddle the pothole.

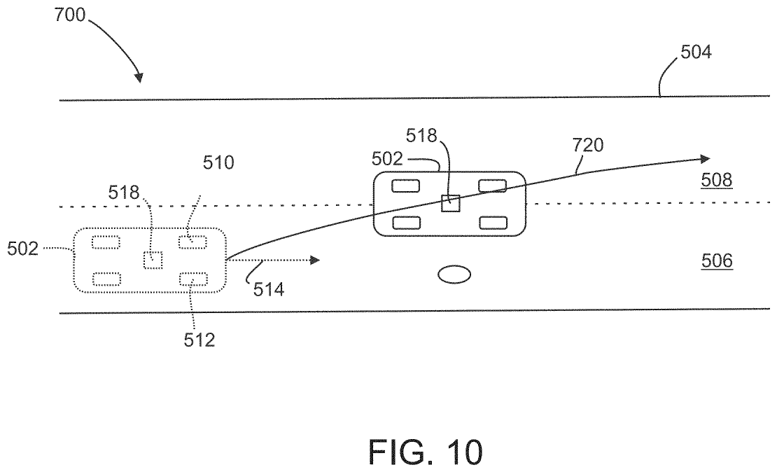

FIG. 10 shows the vehicle of FIG. 8 performing an avoidance behavior to navigate around the pothole.

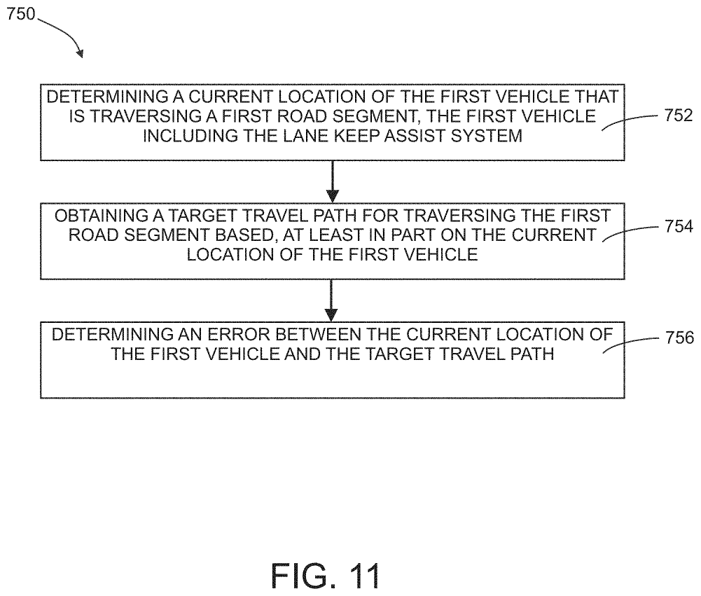

FIG. 11 is a flowchart showing a method of operating a terrain-based lane keep assist system of a vehicle.

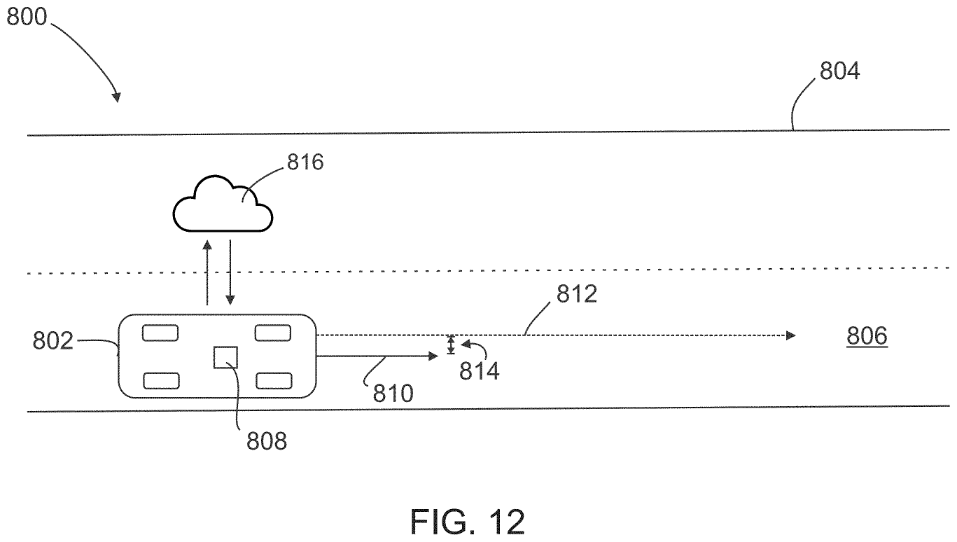

FIG. 12 shows a vehicle equipped with a terrain-based advanced driver assistance system traveling on a road segment on a path offset from a center of a lane.

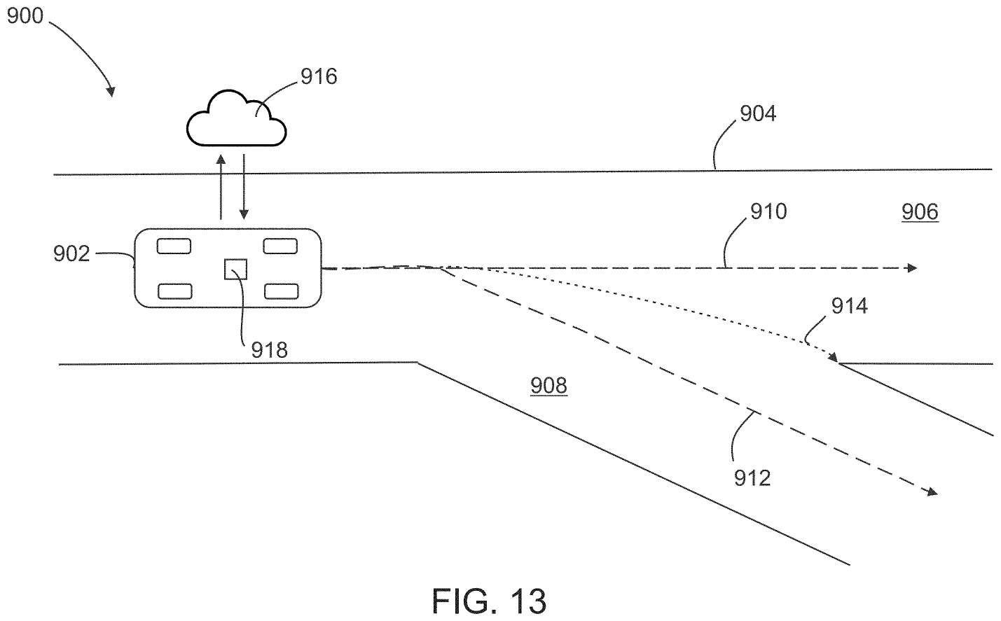

FIG. 13 shows a vehicle equipped with a terrain-based advanced driver assistance system traveling on a road segment with an exit lane.

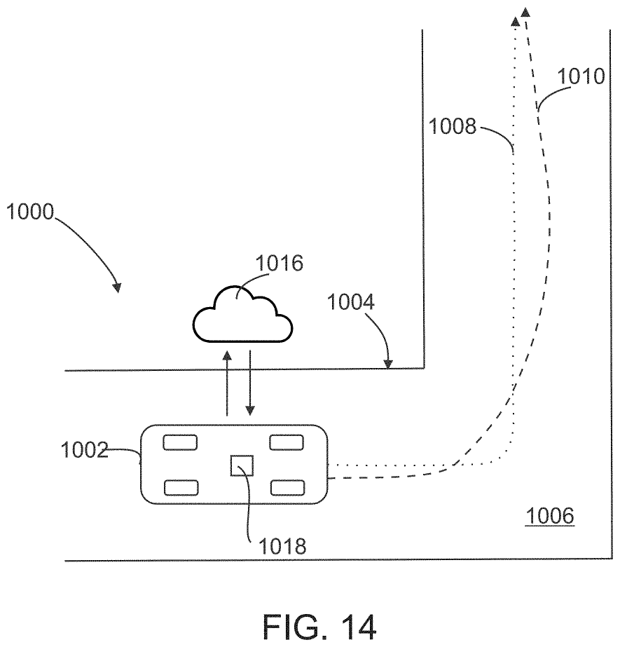

FIG. 14 shows a vehicle equipped with a terrain-based advanced driver assistance system traveling on a road segment with a left-hand turn.

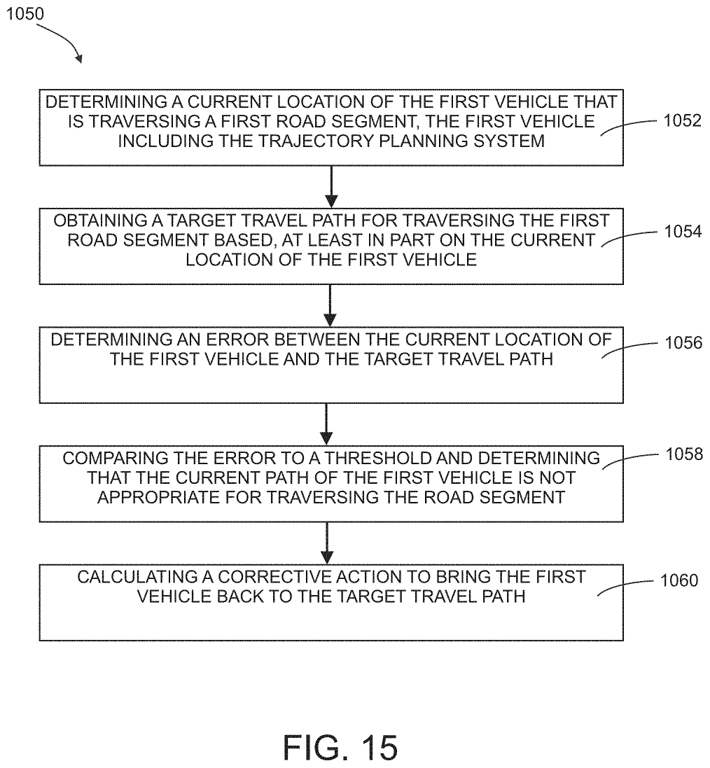

FIG. 15 is a flowchart showing a method of operating a trajectory planning system of a vehicle.

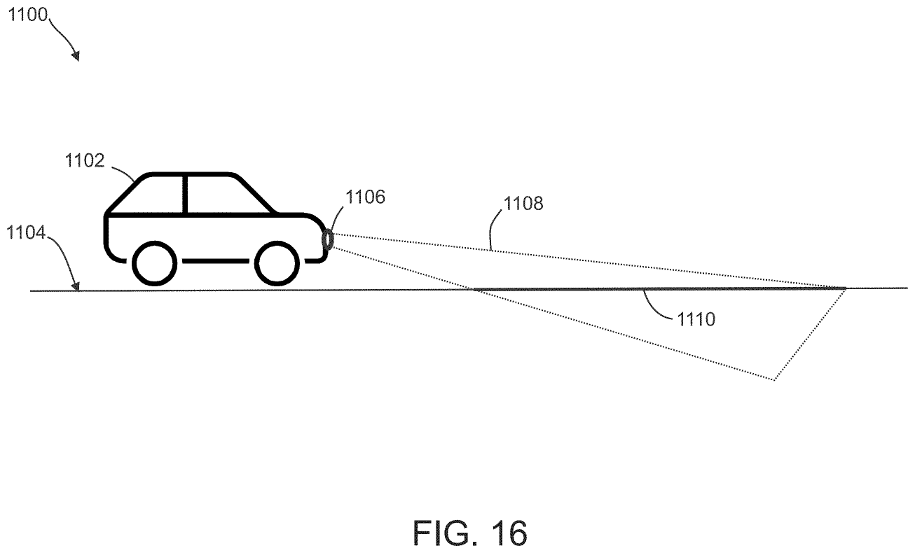

FIG. 16 shows a zone of headlight illumination for a vehicle traveling on a flat road surface.

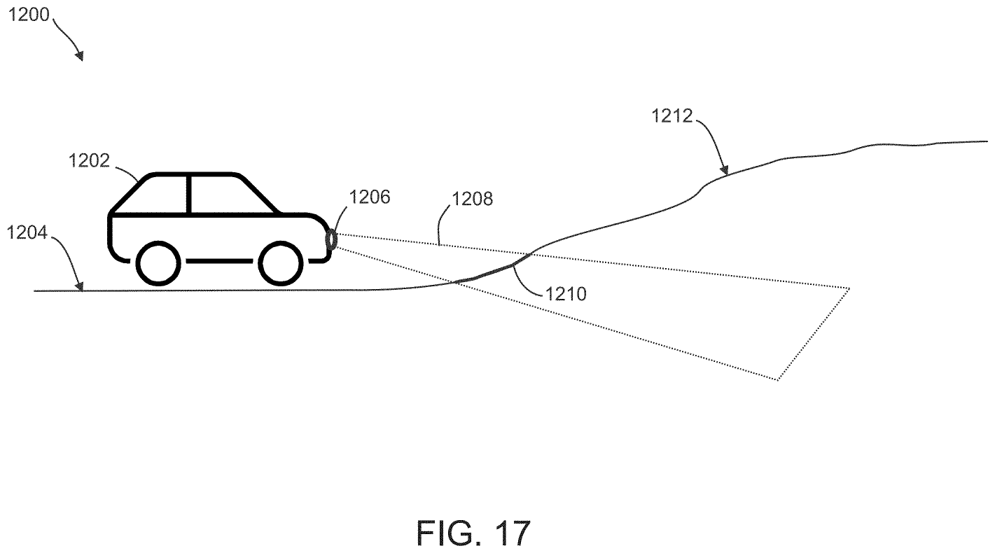

FIG. 17 shows a zone of headlight illumination for a vehicle with a terrain-based adaptive headlight system turned off.

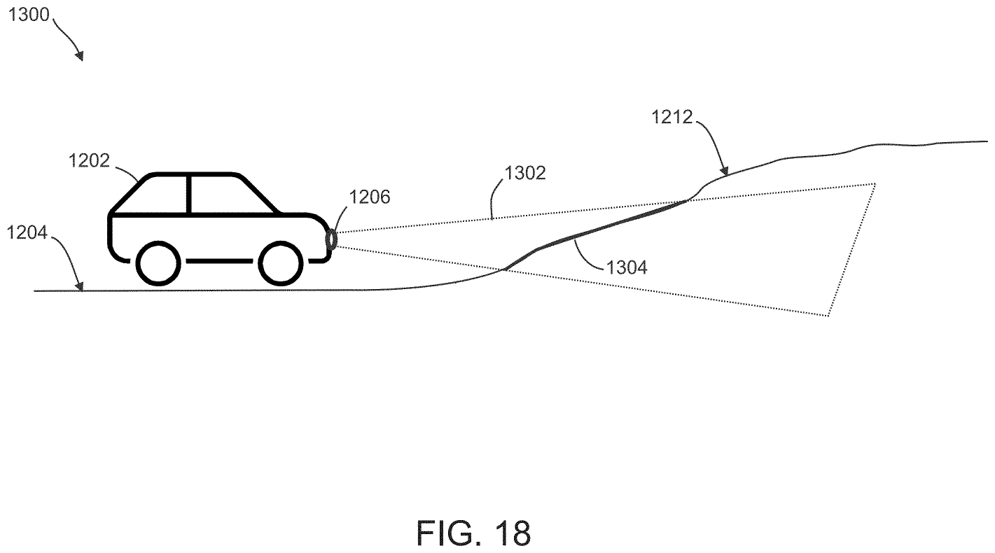

FIG. 18 shows a zone of headlight illumination for a vehicle with a terrain-based adaptive headlight system turned on.

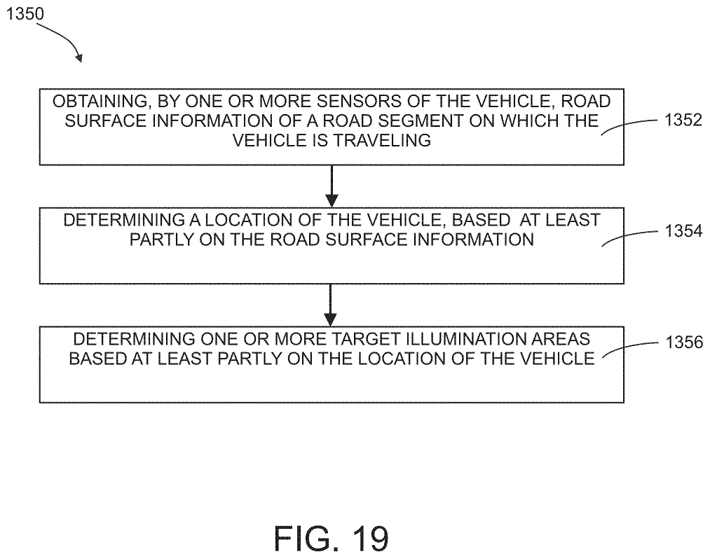

FIG. 19 is a flowchart showing a method for providing a terrain-based insights to an adaptive headlight system of a vehicle.

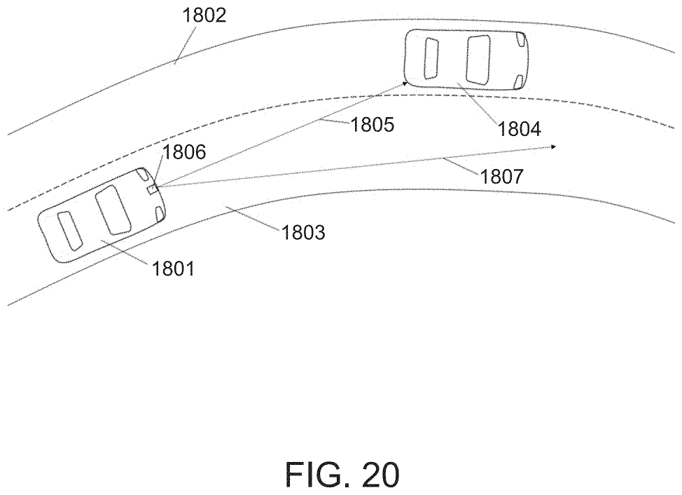

FIG. 20 illustrates a vehicle with a sensor system configured to be adapted based on terrain-based information.

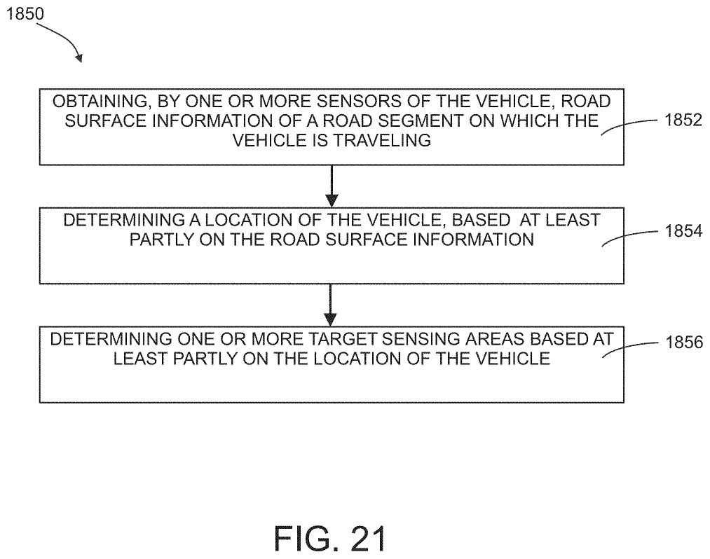

FIG. 21 is a flowchart showing a method for providing terrain-based insights to an adaptive ADAS sensor system of a vehicle.

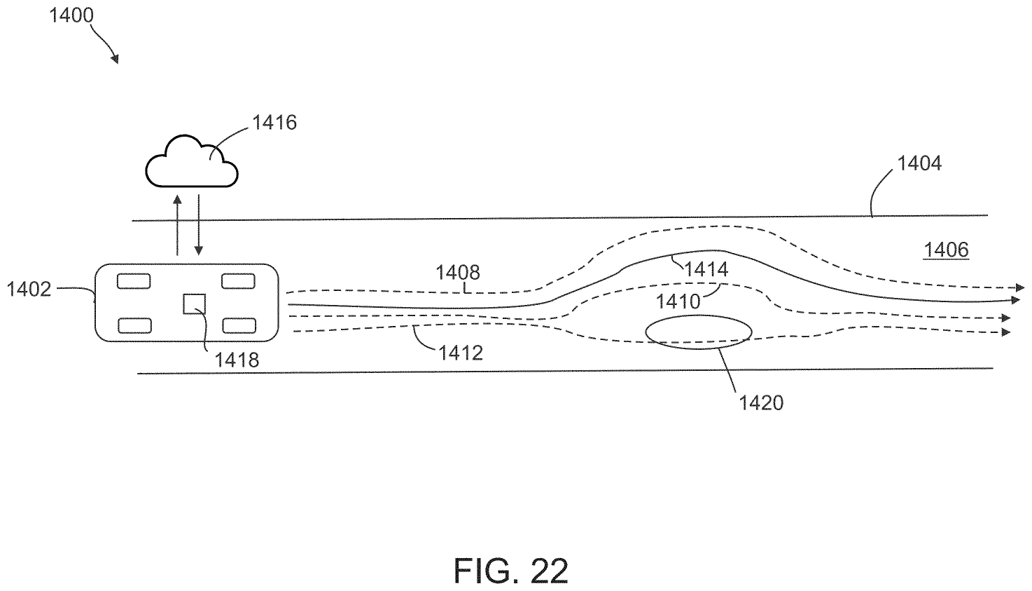

FIG. 22 shows a vehicle traveling on a road segment where a plurality of paths of previous drives have been combined into an aggregate path.

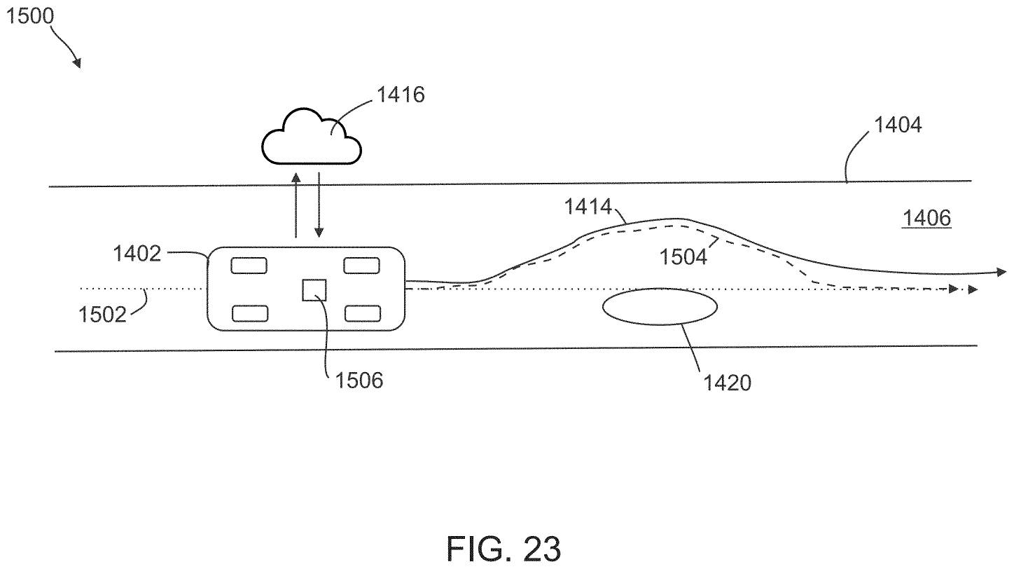

FIG. 23 depicts a vehicle utilizing the aggregate path in conjunction with a rear steering correction system to avoid an obstacle.

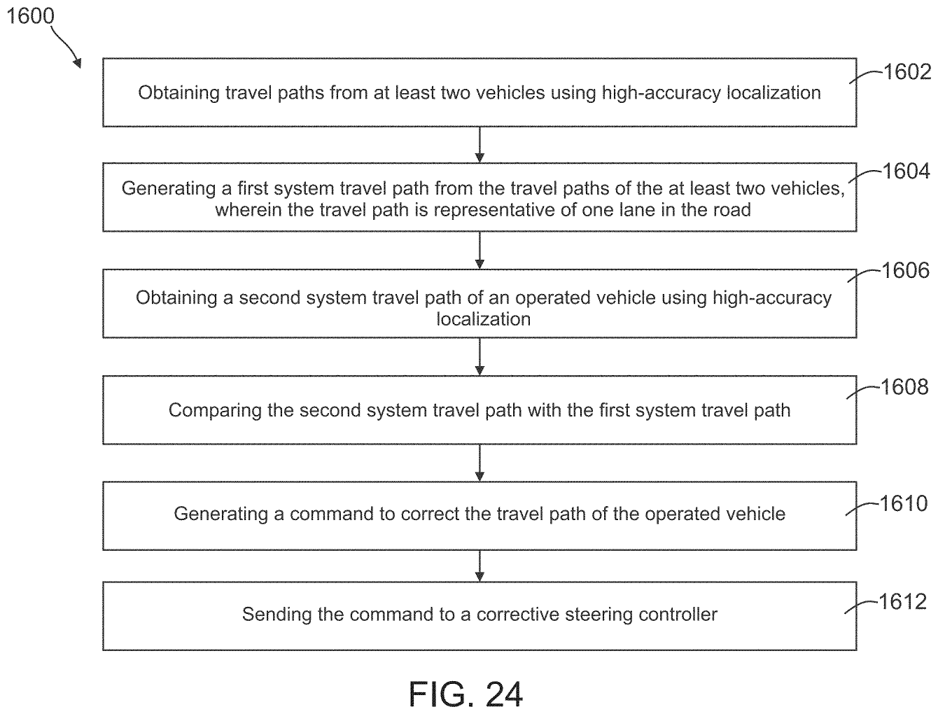

FIG. 24 is a flowchart of a method using crowd-sourced travel path data to generate a command for a rear steering correction system.

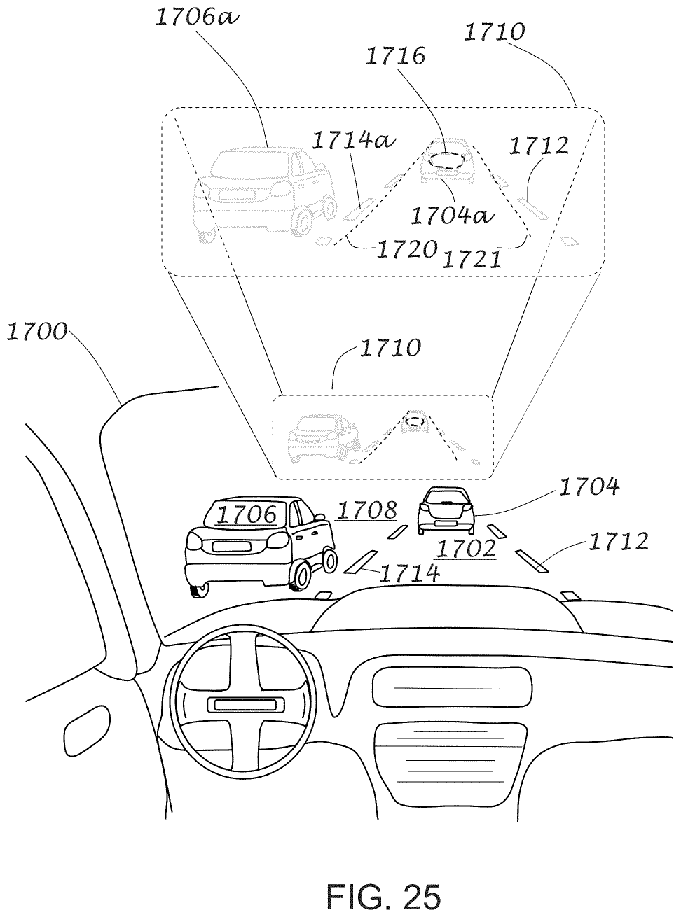

FIG. 25 illustrates a vehicle with a heads-up display configured to illustrate obscured road surface features.

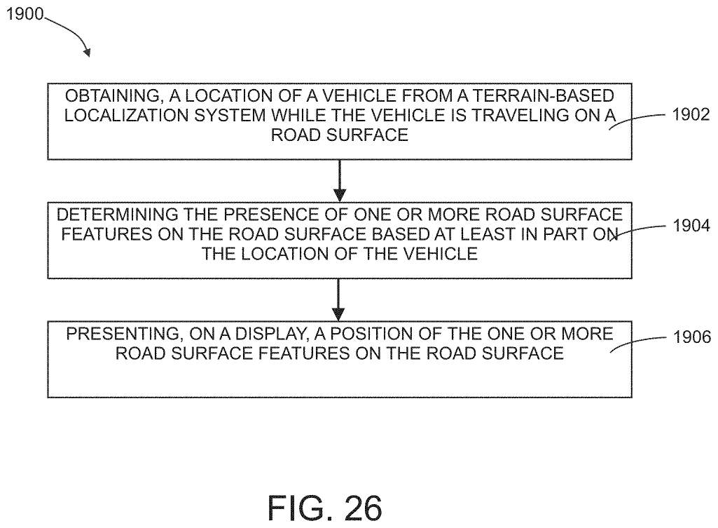

FIG. 26 is a flowchart showing a method of presenting obscured road surface features on a display.

### DETAILED DESCRIPTION

A vehicle traveling along a road, autonomously or under the control of a driver, may interact with one or more road surface features that may expose the vehicle and/or one or more vehicle occupants to certain forces or accelerations. Such road features may affect the comfort of vehicle occupants as well as wear-and-tear of the vehicle. The magnitude, direction, and/or frequency content of such forces or accelerations may be a function of the characteristics of one or more road surface features. A typical road may include various types of road surface features, such as for example, road surface anomalies including, but not limited to potholes, bumps, surface cracks, expansion joints, frost heaves, rough patches, rumble strips, storm grates, etc.; and/or road surface properties, including but not limited to road surface texture, road surface composition, surface camber, surface slope, etc. Road surface properties may affect road surface parameters, such for example, the friction coefficient between the tires of a vehicle and the road, traction and/or road-grip. Such parameters may determine how effectively certain maneuvers, such as turning and stopping, may be performed at various speeds and vehicle loading.

The inventors have recognized the benefits of controlling operation of various systems of a vehicle based on the above-noted road surface properties and features. However, the types and characteristics of road surface features and/or properties may vary, for example, from road to road, as a function of longitudinal and/or lateral location on a given road. The effect of vehicle interaction with a given road surface feature, on the vehicle and/or an occupant, may also vary as a function of vehicle speed at the time of the interaction between the vehicle and the road surface feature. The characteristics of a road surface feature may also vary, for example, based on weather conditions, and/or as a function of time. For example, if the road surface feature is a pothole, it may gradually appear and grow, in length, width, and/or depth, over the winter months because of repeated freeze/thaw cycles and then be repaired in a matter of hours or less and effectively disappear. Due to the changing nature, and previously unmapped layout, of a road surface, typically vehicles have sensed the interactions of a vehicle with the road surface and then operated the various autonomous and/or semi-autonomous systems of the vehicle in reaction to the detected characteristics and road surface features the vehicle encounters.

Properties and road surface features of a road surface a vehicle might be driven over may be mapped to provide forward-looking information about the road surface features located along a path of travel of a vehicle. This information about the road surface features ahead of the vehicle may be used to, for example, dynamically tune, prepare, and/or control various automated or partially automated systems in the vehicle (such as for example, suspension systems (e.g., semi or fully active), propulsion systems, adaptive driver assistance systems (ADAS), electric power steering systems (EPS), antilock braking systems (ABS), etc.). The inventors have recognized that when there is a physical interaction between a vehicle and a road surface feature, the vehicle is exposed to one or more perceptible forces that are induced by the interaction. Thus, with a preview of the road ahead, a vehicle controller may more effectively react to road surface features when there is a physical interaction between the road surface feature and the vehicle.

While information about a road surface may be useful for the control of various systems of a vehicle, the inventors have recognized that there are challenges to obtaining and using such road surface information. One such challenge is knowing with sufficient accuracy and resolution the location of the vehicle, so that the information regarding road features ahead of the vehicle may be used to more effectively control the vehicle. For example, if the location of the vehicle is not sufficiently accurate, a vehicle controller may take an action that does not mitigate a physical interaction between the vehicle and the road feature. As another example, if the location of the vehicle is not sufficiently accurate, a vehicle controller may take an action that worsens a physical interaction between the vehicle and the road feature or otherwise worsens a vehicle occupant's comfort. For example, an accuracy on Global Navigation Satellite Systems (GNSS) location tends to be on the order of about 7 m to 30 m. With such an accuracy, a vehicle would not only be unable to tell when a vehicle would interact with a particular road surface feature (e.g., a pothole) but it also would be unable to tell if the vehicle would interact with that road surface feature in any manner.

In view of the above, the inventors have recognized that localization systems and methods incorporating terrain-based localization may offer better resolution than a purely GNSS based system. In a terrain-based localization system, as a vehicle travels along a road, a measured road profile may be obtained by measuring vertical motion of a portion of the vehicle using one or more motion sensors attached to the vehicle. This measured road profile may be compared with a reference road profile, and based at least in part on this comparison, the position of the vehicle along the road may be determined. However, the inventors have recognized that continuous pattern matching between a measured profile and a reference profile may require substantial data transmission and/or manipulation. That is, a single vehicle may need to stream sufficient road information such that the measured road profile may be continuously compared to the reference road profile while the vehicle is controlled based on the forward road information. The network bandwidth requirements may be substantial for a system employing a plurality of vehicles across an entire road network such that implementing such a network may not be commercially feasible. Additionally, continuous pattern matching between a measured profile and a reference profile may require computing power beyond what is commercially feasible to employ in a vehicle. If the computation is done remotely, such continuous pattern matching further requires network bandwidth which may already be commercially unfeasible.

In view of the above, the inventors have recognized the benefits of a road segment organizational structure for road information and related methods that provide accurate terrain-based localization in a discretized manner, thereby reducing network and computational requirements to implement terrain-based localization. Each road segment may have a predetermined length, such that a road is broken into multiple road segments. As a vehicle approaches an end point of a road segment, a road profile of the road segment may be compared with the last portion of a measured road profile with an approximately equivalent length. In this manner, a vehicle may verify its precise position based on terrain once per road segment of a predetermined length, a method which is less computationally and network bandwidth intensive.

The inventors have recognized that, given computational and/or bandwidth limitations, it may be advantageous to implement a terrain-based localization method such that the comparison between observed data and reference data occurs only at predetermined intervals (e.g., time or distance intervals). However, in between these precise determinations of a vehicle's location using terrain-based localization, a vehicle's location may become less certain as the vehicle travels further away from the last recognized road surface feature. Thus, in certain embodiments, in between these predetermined intervals and/or road surface locations, dead-reckoning may be used to estimate the location of the vehicle (e.g., the position of the vehicle along a road) based on the previously identified location (e.g., the previously identified position along the road). For example, in certain embodiments and as described in detail herein, a terrain-based localization method may include first collecting, as a vehicle travels along a road, data from one or more sensors attached to the vehicle. The collected data may be processed (e.g., transformed from time to distance domain, filtered, etc.) to obtain measured data (e.g., a measured road profile). The measured data may then be compared with reference data associated with the road (e.g., a reference or stored road profile) and, based at least in part on this first comparison, a position of the vehicle along the road at a first point in time may be determined. Once the position of the vehicle along the road at the first point in time is determined, dead reckoning may be used to track the vehicle's position as it subsequently travels along the road. During the period of dead reckoning, new data from the one or more sensors may be collected and optionally processed to yield new observed data. In certain embodiments, upon determining that the vehicle has traveled a predetermined distance since the first point in time, the new observed data may be compared with reference data. Based at least upon this second comparison, the position of the vehicle along the road at a second point in time may be determined. The process may then be repeated as the vehicle traverses sequentially located road segments, such that dead reckoning is used to track further movement of the vehicle, until it is determined that the vehicle has traveled the predetermined distance since the second point in time the location was determined. Upon this determination, terrain-based localization may be used to localize the vehicle at a third point in time. Thus, in some embodiments comparisons may be carried out intermittently at predetermined distance intervals, which may be constant intervals, instead of continuously comparing measured (e.g., the collected data and/or the processed data) data with reference data. Alternatively or additionally, terrain-based localization may be carried out upon determining that a predetermined time interval has passed since the first or previous point in time, rather than a predetermined distance interval. During these time/distance intervals, dead-reckoning may be used, exclusively or in addition to other localization systems that may be used to track the location (e.g., coordinates or position) of the vehicle based on a previously established location. Additionally, while the use of constant time and/or distance intervals are primarily disclosed herein, it should be understood that predetermined time and/or distance intervals used when determining a vehicle's location on different road segments may either be constant and/or variable between each other along different road segments as the disclosure is not limited in this fashion.

The inventors have also recognized that terrain-based determination of location for a vehicle may be supplemented by GNSS location estimations and the use of discretized road segments. That is, rather than using dead reckoning to perform terrain-based comparisons in discrete time and/or distance intervals, a location estimation from a GNSS system may be employed. For example, in certain embodiments and as described in detail herein, a terrain-based localization method may include first collecting, as a vehicle travels along a road, data from one or more sensors attached to the vehicle. The collected data may be processed (e.g., transformed from time to distance domain, filtered, etc.) to obtain measured data (e.g., a measured road profile). The measured data may then be compared with reference data associated with the road (e.g., a reference or stored road profile) and, based at least in part on this first comparison, a position of the vehicle along the road at a first point in time may be determined. Once the position of the vehicle along the road at the first point in time is determined, a GNSS may be used to track the vehicle's position as it subsequently travels along the road which may be used to determine a distance the vehicle has traveled along the road since the vehicle location was determined. During the period of GNSS tracking, new data from the one or more sensors may be collected and optionally processed to yield new observed data. In certain embodiments, upon determining that the vehicle has traveled a predetermined distance since the first point in time based at least in part on the GNSS tracking data, the new observed data may be compared with reference data. Based at least upon this second comparison, the position of the vehicle along the road at a second point in time may be determined. The process may then be repeated, such that GNSS tracking is used to track further movement of the vehicle, until it is determined that the vehicle has traveled the predetermined distance since the second point in time. Upon this determination, terrain-based localization may be used to localize the vehicle at a third point in time. Thus, in some embodiments, comparisons may be carried out intermittently at predetermined distance intervals, which may be constant intervals, or in some instances non-constant predetermined distance intervals associated with the different road segments, instead of continuously comparing measured (e.g., the collected data and/or the processed data) data with reference data. In some cases, employing a GNSS instead of dead reckoning may reduce error related to the predetermined distance. In some embodiments, GNSS may be used in combination with dead reckoning to further reduce error related to the predetermined distance, as the present disclosure is not so limited.

In some embodiments, in a road segment architecture, a given road may be segmented into a series of road segments of predetermined lengths that in some embodiments may be equal to each other, though embodiments in which road segments of unequal predetermined lengths are used are also contemplated. Each road segment may include one or more road profiles that may be employed for terrain-based localization as described herein.

The road profiles may be obtained by measuring vertical motion of a portion of a vehicle using one or more motion sensors attached to the vehicle as the vehicle traverses the road segment. The road segments of predetermined equal lengths or unequal lengths may be referred to as “slices”. In certain embodiments, consecutive road segments may be arranged in a contiguous fashion such that the end point of one road segment approximately coincides with the starting point of a subsequent road segment. In some embodiments, the consecutive road segments may be non-overlapping, such that an end point of one road segment coincides with a starting point of a subsequent road segment. Alternatively, in some embodiments, road segments may overlap, such that the start point of a subsequent road segment may be located within the boundaries of a previous road segment. Road segments may be, for example, any appropriate length, including, but not limited to, ranges between any combination of the following lengths: 20 meters, 40 meters, 50 meters, 60 meters, 80 meters, 100 meters, 120 meters, 200 meters or greater. In some embodiments, a road segment may have a length between 20 and 200 meters, 20 and 120 meters, 40 and 80 meters, 50 and 200 meters, and/or any other appropriate range of lengths. Other lengths that are longer or shorter than these lengths are also contemplated, as the present disclosure is not so limited. In certain embodiments, the length of the road segment into which a road is divided may depend on the type of road and/or the average speed travelled by vehicles on the road or other appropriate considerations. For example, on a single lane city road, vehicles may generally travel at relatively low rates of speed as compared to multilane highways. Therefore, on a city road (or other road with relatively low travel speeds) it may be advantageous or otherwise desirable to have relatively shorter road segments (e.g., between 20 and 60 meters) than on highways or other roads with relatively high travel speeds (e.g., between 80 and 120 meters), such that each road segment may correspond to an approximate average travel time from start to end of the road segment regardless of average travel speed on the road.

In some embodiments, a method of localizing a vehicle using road segments includes measuring a road profile with a vehicle. The method may also include determining is a vehicle is within a threshold distance of a road segment end point. For example, in some embodiments, determining the vehicle is within a threshold distance of a road segment endpoint includes estimating a location of the vehicle with a GNSS, dead reckoning from a last known vehicle location, and/or any other appropriate localization method. The method may also include comparing a reference road profile corresponding to the end portion of the road segment along a vehicle's path of travel to the measured road profile. In some embodiments, a last portion of the measured road profile may be compared to the reference road profile as the vehicle traverses the road segment, where the last portion of the measured road profile and reference road profile have approximately equal (e.g., equal) lengths. The method may include determining a correlation between the measured road profile and the reference road profile, for example, using a cross-correlation function or another appropriate function that assesses similarity between the measured road profile and the reference road profile (e.g., dynamic time warping, etc.). The method may also include determining if the correlation between the measured road profile and the reference road profile exceeds a threshold correlation. The threshold correlation may be predetermined based at least in part on a road type, as will be discussed in detail further below. If the correlation exceeds the threshold correlation, the location of the vehicle may be determined, as the position of the vehicle may correspond to the location of the road segment end point. If the correlation does not exceed the threshold correlation, the location of the vehicle may not be determined, and the method may continue with the vehicle advancing down the road and re-determining a correlation between the measured road profile (including additional data measured while advancing down the road) and the reference road profile. In addition to the above, as the vehicle approaches the endpoint of the last portion of the road profile, the correlation between the measured road profile and the reference road profile may increase to a peak at a location corresponding approximately to the endpoint of the reference road profile. Accordingly, in some embodiments, the method may include detecting a peak in the correlation between the measured road profile and the reference road profile while the vehicle moves through an area within a threshold distance of the road segment end point. Additional details of such peak detection are discussed in further detail below.

The various embodiments disclosed herein are related to determining the location of a vehicle on a road surface and/or for creating maps of road segments including information that may be used to locate a vehicle on a road surface. Such information may provide a priori information to a vehicle about one or more road surface features and/or road surface properties located on the road segment along an upcoming portion of the path of travel of the vehicle. As noted previously, by knowing this information prior to the vehicle encountering a given portion of a road segment, operation of one or more systems of a vehicle, e.g., autonomous and/or semi-autonomous systems of the vehicle, may be at least partly controlled based on this information. Accordingly, any of the embodiments disclosed herein may provide information, e.g., vehicle, road surface feature, and/or road parameter locations, that may be used by one or more vehicles to control one or more vehicle systems. Thus, in some embodiments, one or more systems of a vehicle may be controlled based at least in part on a determined location of a vehicle, dead reckoning, a reference profile of a road segment, and combinations of the foregoing. Examples of systems that may be controlled may include suspension systems (semi or fully active), propulsion system, advanced driver assistance systems (ADAS), electric power steering (EPS), antilock braking systems (ABS), navigation systems of autonomous vehicles, and/or any other appropriate type of vehicle system.

According to exemplary embodiments described herein, a vehicle may include one or more wheels and one or more vehicle systems that are controlled by a vehicle control system. A vehicle control system may be operated by one or more processors. The one or more processors may be configured to execute computer readable instructions stored in volatile or non-volatile computer readable memory that when executed perform any of the methods disclosed herein. The one or more processors may communicate with one or more actuators associated with various systems of the vehicle (e.g., braking system, active or semi-active suspension system, driver assistance system, etc.) to control activation, movement, or other operating parameter of the various systems of the vehicle. The one or more processors may receive information from one or more sensors that provide feedback regarding the various portions of the vehicle. For example, the one or more processors may receive location information regarding the vehicle from a Global Navigation Satellite System (GNSS) such as a global positioning system or other positioning system. The sensors on board the vehicle may include, but are not limited to, wheel rotation speed sensors, inertial measurement units (IMUs), optical sensors (e.g., cameras, LIDAR), radar, suspension position sensors, gyroscopes, etc. In this manner, the vehicle control system may implement proportional control, integral control, derivative control, a combination thereof (e.g., PID control), or other control strategies of various systems of the vehicle. Other feedback or feedforward control schemes are also contemplated, and the present disclosure is not limited in this regard. Any suitable sensors in any desirable quantities may be employed to provide feedback information to the one or more processors. It should be noted that while exemplary embodiments described herein may be described with reference to a single processor, any suitable number of processors may be employed as a part of a vehicle, as the present disclosure is not so limited.

According to exemplary embodiments described herein, one or more processors of a vehicle may also communicate with other controllers, computers, and/or processors on a local area network, wide area network, or internet using an appropriate wireless or wired communication protocol. For example, one or more processors of a vehicle may communicate wirelessly using any suitable protocol, including, but not limited to, WiFi, GSM, GPRS, EDGE, HSPA, CDMA, and UMTS. Of course, any suitable communication protocol may be employed, as the present disclosure is not so limited. For example, the one or more processors may communicate with one or more servers from which the one or more processors may access road segment information. In some embodiments, one or more servers may include one more server processors configured to communicate in two-way communication with one or more vehicles. The one or more servers may be configured to receive road profile information from the one or more vehicles, and store and/or utilize that road profile information to form road segment information. The one or more servers may also be configured to send reference road profile information to one or more vehicles, such that a vehicle may employ terrain-based localization according to exemplary embodiments described herein, and one or more vehicle systems may be controlled or one or more parameters of the one and/or more vehicle systems may be adjusted based on forward looking road profile information.

In the various embodiments described herein, in some instances, a method of terrain-based localization may be based on peak detection of a cross-correlation between a reference road profile and a measured road profile as a vehicle passes through a road segment end point. In some embodiments, a measured road profile of a predetermined length approximately equivalent to that of the reference road profile may be cross correlated to the reference road profile once the vehicle enters a threshold range of the road segment end point to obtain a correlation between 0 and 1. In some embodiments, the threshold range of the road segment end point may be less than 15 m, 10 m, 5 m, and/or any other appropriate range. In some embodiments, the threshold range of the road segment end point may be based at least partly on a resolution of a GNSS onboard the vehicle. In such embodiments, the threshold range may be approximately equal (e.g., equal) to the resolution of the GNSS.

According to exemplary embodiments described herein, once a vehicle enters the threshold range of the road segment end point, a cross correlation between the measured road profile and reference road profile may be performed and the correlation determined. If the correlation does not exceed a threshold correlation, the vehicle location may not be determined, and the process of terrain-based localization may continue with the vehicle continuing to move down the road. While the vehicle is within the threshold range of the road segment end point, a correlation may be re-determined effectively continuously (e.g., at each time step) as the measured road profile includes the most recent data from the vehicle and removes the oldest data falling outside of the predetermined length. Each time a correlation is determined, it may be determined if the correlation exceeds the threshold correlation. Once the correlation exceeds the threshold correlation at a given time step, it may be determined that the vehicle was located at the road segment end point at that time step. In some embodiments, a peak detection algorithm may be applied to determine if the correlation between the measured road profile and reference road profile is a maximum correlation. In some such embodiments, a slope of the correlation may be determined between the most recent time step and earlier time steps. In some embodiments, a peak may be determined where the slope is negative, and the correlation is decreasing after the correlation exceeded the threshold correlation. Of course, any suitable peak detection function may be applied, as the present disclosure is not so limited. In some embodiments, a threshold correlation may be greater than or equal to 0.6, 0.7, 0.8, 0.9, and/or any other appropriate value. In some embodiments, the threshold correlation may be based at least party on the type of road segment. For example, a highway or high-speed road may have a greater threshold correlation than a low-speed road where more variations in a path taken by a vehicle may be present. According to this example, in some embodiments, a threshold correlation for a highway may be greater than or equal to 0.8, and a threshold correlation for a non-highway road may be greater than or equal to 0.5.

According to exemplary embodiments described herein, road segment information may be stored in one or more databases onboard a vehicle and/or in one or more remotely located servers. In some embodiments, a database may be contained in non-transitory computer readable memory. In certain embodiments, the database may be stored in memory that is exclusively or partially located remotely (e.g., “in the cloud”) from the vehicle, and the database and the vehicle may exchange information via a wireless network (e.g., a cellular network (e.g., 5G, 4G), WiFi, etc.). Alternatively, in some embodiments, the database may be stored in non-transitory memory that is located on the vehicle. In certain embodiments. Road segments may be specific for a direction of travel, such that for “two-way” roads (i.e., roads which support simultaneous travel in opposing directions), there may be a distinct set of road segments for each direction of travel (e.g., a first set of road segments for travel in a first direction and a second set of distinct road segments for travel in a second direction).

As used herein, road profile refers to any appropriate description or characterization of a road surface as a function of distance. For example, a road profile may refer to a road height profile that describes variations of height of a road's surface as a function of distance along a given road segment. Alternatively or additionally, a road profile may refer to mathematically related descriptions of road surface. For example, a road profile may refer to a “road slope” profile that describes road slope as a function of distance along a road segment. A road profile of a road segment may be obtained, for example, by measuring—as a vehicle traverses the road segment—vertical motion (e.g., acceleration data, velocity data, position data) of a portion of the vehicle (e.g., to the vehicle's wheel, wheel assembly, or other part of the unsprung mass; or a portion of the vehicle's sprung mass), and optionally processing this data (e.g., transforming it from time to distance domains based on operating speed, integrating the data with respect to time, filtering it (e.g., to remove wheel hop effects), etc.). For example, if vertical acceleration of a wheel is measured using an accelerometer attached to the wheel, then vertical velocity of the wheel may be obtained through integration, and vertical height obtained through further integration. With knowledge of the operating speed of the vehicle (that is, the speed at which the vehicle traverses the road segment), vertical height with respect to distance travelled may be obtained. In some embodiments, further filtering may be advantageous. In one example, a road height profile may be obtained from the wheel's vertical height data (e.g., as determined by measuring acceleration of the wheel) by applying a notch filter or low-pass filter (to, e.g., measured vertical acceleration of the wheel) to remove effects of wheel hop. A road profile may incorporate information describing or characterizing discrete road surface anomalies such as, for example, potholes (or other “negative” events) and/or bumps (or other “positive” events). Additionally or alternatively, a road profile may incorporate information about distributed road surface characteristics such as road roughness and/or road surface friction. Additionally or alternatively, a road profile may incorporate information about any parameter that may be measured that is related to a motion and/or response of the vehicle to inputs from the road to the vehicle (e.g., forces, accelerations, heights, etc.).

According to exemplary embodiments described herein, if a vehicle travels on a road (or section of a road) for which no reference road profile data exists, reference data (including, e.g., a reference road profile, characterization of the road's surface, and/or the presence of irregular events such as bumps or portholes) may be generated by collecting motion data from one or more motion sensors (e.g., accelerometers, position sensors, etc.) attached to one or more points of the vehicle (e.g., attached to a wheel of the vehicle, a wheel assembly of the vehicle, a damper, another part of the unsprung mass of the vehicle, or a part of the sprung mass of the vehicle). Data collected from a first traversal of the road or road section may then be used to generate the reference data that may be stored in a database and associated with the particular road segment of the road or road section. Alternatively, data may be collected from a plurality of vehicle traversals and merged (e.g., averaged using a mean, mode, and/or median of the reference data) together to generate reference data.

According to exemplary embodiments described herein, the location of a vehicle may be estimated or at least partially determined by, for example, absolute localization systems such as satellite-based systems. Such systems may be used to provide, for example, absolute geocoordinates (i.e., geographic coordinates on the surface of the earth such as longitude, latitude, and/or altitude) of a vehicle. Satellite based systems, generally referred to as a Global Navigation Satellite System (GNSS), may include a satellite constellation that provides positioning, navigation, and timing (PNT) services on a global or regional basis. While the US based GPS is the most prevalent GNSS, other nations are fielding, or have fielded, their own systems to provide complementary or independent PNT capability. These include, for example: BeiDou/BDS (China), Galileo (Europe), GLONASS (Russia), IRNSS/NavIC (India) and QZSS (Japan). Systems and methods according to exemplary embodiments described herein may employ any suitable GNSS, as the present disclosure is not so limited.

According to exemplary embodiments described herein, dead reckoning may either be used to determine a location of the vehicle at a time point after the vehicle's last known location using the vehicle's measured path of travel and/or displacement from the known location. For example, the distance and direction of travel may be used to determine a path of travel from the known location of the vehicle to determine a current location of the vehicle. Appropriate inputs that may be used to determine a change in location of the vehicle after the last known location of the vehicle may include, but are not limited to, inertial measurement units (IMUs), accelerometers, sensor on steering systems, wheel angle sensors, relative offsets in measured GNSS locations between different time points, and/or any other appropriate sensors and/or inputs that may be used to determine the relative movement of a vehicle on the road surface relative to a previous known location of the vehicle. This general description of dead reckoning may be used with any of the embodiments described herein to determine a location of the vehicle for use with the methods and/or systems disclosed herein.

In some cases, roads may include more than one track (e.g., lane) for each direction of travel, and the road profile may differ for each track. It may not be known in a reference database how many tracks (e.g., lanes) are in a road or road segment, which may lead to difficulties when generating reference data for the road or road section. For example, if a reference road profile for a given road is generated by a vehicle travelling in the left-most lane of a multi-lane road, subsequent attempts to use said reference road profile to localize a vehicle travelling in the right-most lane may fail due to differences in road surface between the left-most lane and the right-most lane. Thus, knowing both how many tracks a road has, and in which track a vehicle is travelling, is desirable for both generating reference road profiles, subsequent localization, and for using the information for controlling a vehicle and/or one or more vehicle systems. Prior attempts at determining a track of a road profile have raised computational challenges, such as data storage for road profiles of multi-lane use (e.g., a lane change) which are not useful for the majority of vehicle traversals of a road segment which occur in a single lane.

In view of the above, the inventors have recognized the benefits of a road segment organizational structure in which multiple road surface profiles may be associated with a single road segment. The road segment structure allows multiple road profiles to be associated with a road segment in a manner that is less data and computationally intensive. Additionally, the inventors have recognized the benefits of a road segment organizational structure which employs a threshold-based approach to collecting and storing road profiles that may be associated with a road track. In particular, the inventors have appreciated that until a sufficiently large number of stored road profiles is reached, clustering and/or merging road profiles may result in inaccurate road profile information.

In some embodiments, a method of identifying a track (e.g., a lane) of a road profile for a road segment includes measuring a road profile of the road segment with any appropriate onboard sensor as disclosed herein as the vehicle traverses the road segment (e.g., employing a vehicle according to exemplary embodiments described herein). A measured road profile may be transmitted to a server each time a vehicle traverses the road segment, such that a plurality of vehicles may transmit a plurality of measured road profiles to the server. The method may also include determining if the number of stored road profiles exceeds a threshold number of road profiles. The threshold number of road profiles may be predetermined to allow a sufficient number of road profiles to be collected prior to data manipulation. In some cases, the threshold number of road profiles may be based on the type of road segment. For example, a high-speed road such as a highway may have a greater threshold number of road profiles as highways typically include more lanes than low speed roads. In some embodiments, the threshold number of road profiles may be between 2 and 64 road profiles, between 8 and 12 road profiles, and/or any other suitable number. If the server receives a road profile from the vehicle and the threshold number of stored road profiles is not exceeded, the received measured road profile may be stored and associated with the road segment. However, if the threshold number of road profiles is exceeded by the received measured road profile, the method may include identifying the most similar two road profiles of the measured road profile and stored road profiles. The most similar two road profiles may be identified based on a cross-correlation function performed on each pair of road profiles, and comparing the resulting degree of similarity values. If the degree of similarity of the two most similar road profiles exceeds a predetermined similarity threshold, the two most similar road profiles may be merged into a merged road profile. If the degree of similarity of the two most similar profiles does not exceed a similarity threshold, the oldest road profile may be discarded, and the newly measured road profile stored. In this manner, similar road profiles may be retained by the server, whereas outlying road profiles will be eventually removed. As similar road profiles are merged, information regarding how many road profiles have been merged into a single merged profile may be kept as metadata, with greater numbers of road profiles in a single merged profile representing a track (e.g., lane) of a road segment.

In some embodiments, a degree of similarity may be a value between 0 and 1 which is the output of a cross-correlation function. In some embodiments, a similarity threshold for merging road profiles may be greater than or equal to 0.6, 0.7, 0.8, 0.9, and/or any other appropriate value. In some embodiments, the similarity threshold may be based at least party on the type of road segment. For example, a highway or high-speed road may have a greater threshold correlation than a low-speed road where more variations in a path taken by a vehicle may be present. According to this example, in some embodiments, a threshold correlation for a highway may be greater than or equal to 0.8, and threshold correlation for a non-highway road may be greater than or equal to 0.5.

In some embodiments, if a set of road profiles includes a sufficiently large number of road profiles (e.g., exceeding a threshold number of road profiles), a correlation clustering algorithm is conducted on the set of road profiles. A number of appropriate correlation clustering algorithms are known in the art, including, for example, hierarchal or partitional clustering methods (e.g., k-means clustering, c-means clustering, principal component analysis, hierarchal agglomerative clustering, divisive clustering, Bayesian clustering, spectral clustering, density-based clustering, etc.) Subsequent to a correlation clustering process, the set of road profiles may be divided into one or more clusters, where each road profile contained within a given cluster is substantially similar to each other road profile contained within the given cluster. For example, the set of road profiles in a road segment may be divided into at least a first cluster of road profiles and a second cluster of road profiles, where each road profile in the first cluster is substantially similar to each other road profile in the first cluster, and each road profile in the second cluster is substantially similar to each other road profile in the second cluster. In some embodiments, a similarity of the plurality of road profiles in each cluster may be more similar to other road profiles in the same road profile as compared to road profiles in other clusters as determined using any appropriate comparison method including, for example, a cross correlation function as described herein. In certain embodiments, each cluster may be considered as corresponding to a track (e.g., a lane) of the road, road segment, or road segment. In certain embodiments, all of the road profiles within a given cluster may be merged (e.g., averaged), in order to obtain a single track-merged road profile. This merged road profile may serve as the reference road profile for a given track within a road segment (e.g., for future terrain-based localization or future preview control of vehicles (e.g., controlling one or more vehicular systems based on knowledge of upcoming road characteristics)), and may be stored in the database and associated with a specific track in a road segment. This merging may be carried out for each identified cluster. In certain embodiments, the clustering algorithm may be periodically repeated (e.g., after a certain number of new road profiles are collected for a given road segment), Alternatively, the clustering algorithm may be repeated after each new road profile is collected to determine which cluster the new profile belongs in.

In some embodiments, rather than considering each cluster to correspond to a track, only clusters having a number of road profiles that exceed a threshold number of road profiles are considered to correspond to tracks. A track represents a path that vehicles take when traversing a road segment. For example, a cluster with a single road profile or a small number of profiles less than the threshold number of road profiles, may be considered an outlier, rather than a separate track. Outliers may occur, for example, when a vehicle experiences an atypical event while traversing a road segment (e.g., the vehicle may change lanes within a road segment, or may traverse some temporary debris or garbage on the road that is not typically present). In certain embodiments, road profiles considered outliers may be deleted after some amount of time in order to save space, not cause confusion, or other appropriate reasons.

According to exemplary embodiments described herein, one or more road profiles may be merged into a merged road profile. In some embodiments, merging two or more road profiles may include averaging the two or more profiles. In some embodiments, merging the two or more road profiles may include accounting for the range of frequencies over which the information provided in a measured road profile is valid. In some instances, two or more measured road profiles may have overlapping, but not identical, valid frequency ranges. In such instances, the overlapping portions may be averaged while the non-overlapping portions may be left unchanged. A reference profile created from multiple overlapping, but not identical, measured road profiles may have a wider valid frequency range than an individual measured road profile. According to such an embodiment, sensors of varying quality and frequency may be merged into a merged profile without distorting the merged road profile, as the most useable data from each measure profile may be combined.

Of course, any suitable technique for merging two or more road profiles may be employed, as the present disclosure is not so limited.

In some embodiments, tracks of consecutive road segments may be linked in the database. These links may form a directed graph showing how tracks on consecutive road segments are visited. For example, a given road may include a first road segment and a second road segment, where the first road segment and second road segment are consecutive. If it is determined that the first road segment contains two tracks (which, in some embodiments, may correspond to physical lanes on a roadway) and the second road segment contains two tracks, each track of the first road segment may be linked in the database to a respective track in the second road segment. This “track linking” may be carried out based on historical trends—for example, if it is observed that a majority of vehicles, or other appropriate threshold, travel from one track (i.e. first road profile) in a first road segment to a corresponding track (i.e. second road profile) in the second road segment those tracks may be linked together in a database containing the road profiles of the various road segments. For example, if vehicles preferably travel from “track 1” in the first road segment to “track 1” in the second road segment, then track 1 of the first road segment may be linked to track 1 in the second road segment. These linkages may be used to predict travel, such that if a vehicle at a given time is localized to “track 1” in the first road segment, it may be assumed that the vehicle is likely to continue to “track 1” in the second road segment. Accordingly, a vehicle may use a track identification to prepare and/or control one or more vehicle systems for an upcoming road profile.

In some embodiments, a road profile may include additional information regarding the vehicle traversal to assist with clustering and/or lane identification according to exemplary embodiments described herein. For example, in some embodiments, a road profile may include an average speed which may be determined by averaging the speeds of vehicles traversing the road segment when measuring the various measured profiles used to determine the road profile. According to such an example, the average speed may assist in lane identification and clustering, as lanes may differ in average speed. For example, in the U.S. a right-most lane may have the lowest average speed whereas the left-most land has the highest average speed. Accordingly, a first track with a lower average speed may be associated with a right-most lane and a second track with a higher average speed may be associated with a left-most lane of a roadway. Of course, any suitable information may be collected and employed to identify a vehicle lane of a road segment, as the present disclosure is not so limited.

As used herein, the term “location” may refer a location of a vehicle expressed in absolute coordinates, or it may refer to a position of a vehicle along a road. A position of a vehicle may be expressed as a distance relative to some feature of a road (e.g., as a distance relative to the start of a road, relative to some intersection, relative to some feature located on the road, etc.).

It should be understood that while specific types of sensors for measuring a road profile are described in the embodiments below, any appropriate type of sensor capable of measuring height variations in the road surface, or other parameters related to height variations of the road surface (e.g., accelerations of one or more portions of a vehicle as it traverses a road surface) may be used as the disclosure is not so limited. For example, inertial measurement units (IMUs), accelerometers, optical sensors (e.g., cameras, LIDAR), radar, suspension position sensors, gyroscopes, and/or any other appropriate type of sensor may be used in the various embodiments disclosed herein to measure a road surface profile of a road segment a vehicle is traversing as the disclosure is not limited in this fashion.

As used herein, an average may refer to any appropriate type of average used with any of the parameters, road profiles, or other characteristics associated with the various embodiments described herein. This may include averages such as a mean, mode, and/or median. However, it should be understood that any appropriate combination of normalization, smoothing, filtering, interpolation, and/or any other appropriate type of data manipulation may be applied to the data to be averaged prior to averaging as the disclosure is not limited in this fashion.

As used herein, a road profile may correspond to a “track” or a “lane”, and in some instances these terms may be used interchangeably. As used herein, a “track” may be a path that one or more vehicles take to traverse a road segment. In some embodiments, “clusters” correspond to “tracks” and/or “lanes”. In some embodiments, “tracks” correspond to physical “lanes” on a road. In other embodiments, “tracks” do not correspond to physical “lanes” on a road.

In the various embodiments disclosed herein, reference may be made to obtaining particular forms of data including, for example, road profiles, road surface information, road event data, road condition data, weather information, vehicle information, etc. It should be understood that obtaining the desired data may correspond to any appropriate manner in which the data may be obtained. This may include, for example: recalling data previously stored in non-transitory computer readable media; receiving real-time measurement signals from one or more associated sensors or systems; receiving transmissions from a remotely located server, vehicle, or other system; and/or any other appropriate method of obtaining the desired data as the disclosure is not limited in this fashion.

In the various embodiments described herein, reference may be made to outputting a particular parameter, indication, or other appropriate type of information. It should be understood that outputting may refer to any appropriate type of output of the indicated information including, for example: outputting the information to a user using a display system; storing the information in non-transitory computer readable media; transmitting the information to another computing device such as a remotely located vehicle and/or server; providing the information to another system and/or computing module for subsequent use; and/or any other appropriate method of outputting the information as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

### Terrain-based Advanced Driver Assistance Systems

Referring to FIG. 1, a system 100 including an Advanced Driver Assistance System (ADAS) configured to operate based on terrain-based insights is shown. A vehicle 102, is configured to gather (104) road data (e.g., using one or more sensors (e.g., wheel accelerometers, body accelerometers, IMUs, etc.)) and determine a road profile 108 based on that road data using one or more microprocessors. The vehicle 102 is also configured to send road profile information to a cloud computing system 106 which may include a cloud database. In some instances, the road data, or some adaptation of the road data, is sent to the cloud computing system and a road profile is determined at the cloud computing system. The vehicle 102 is also configured to send vehicle information 110 to the cloud computing system 106. Vehicle information 110 may include a GPS location of the vehicle 102. Vehicle information 110 may include, for example, a make of the vehicle, a model of the vehicle, a type of vehicle (e.g., sports car, sedan, SUV, pickup truck, etc.), information on equipment of the vehicle (e.g., sensor positioning, sensor details, etc.), a driving type of the vehicle (e.g., autonomous, semi-autonomous, human-driven, etc.), an estimated tire type, an estimated tire wear condition, etc. Vehicle information 100 may also include, for example, information about a driver of the vehicle (e.g., a driver profile, an average reaction time, etc.).

The cloud computing system 106 receives (112) the road profile 108 and at least one piece of vehicle information 110. Based on the received road profile 108, the vehicle information 110, and cloud database information 114, the cloud computing system 106 determines (116) a precise location of the vehicle 102. In some implementations, the receiving step 112 may not occur and the database information 114 may be sent to the vehicle where the determination step 116 may occur locally at the vehicle. In some implementations, the entire database or parts of the database may be locally stored at a preceding time, and the process described here may be entirely performed locally with no need to connect to the cloud until more up-to-date information is desired. The database information 114 may include stored road profiles from previous drives over road segments performed by the vehicle 102 or other vehicles. Determining a precise location of the vehicle may include matching the received road profile 108 and with a stored road profile from the cloud database using the received road profile 108 and a GPS location of the vehicle 102 received by the cloud computing system 106. As used herein, the term “precise location” refers to being within 1-meter and/or a location accuracy that is more precise than a typical GPS or other GNSS system, for example by one or more orders of magnitude. The precise location is received (118) by the vehicle 102.

The cloud computing system 106 is configured to determine (120), using the road profile 108, and vehicle information 110, a recommended vehicle operating parameter for traversing at least a portion of an upcoming road segment, an upcoming road event, etc. The recommended vehicle operating parameter may be calculated (120) in the cloud computing system 106 using previous road data (e.g., road condition information, road event information, etc.) from other vehicles that previously drove on the upcoming road segment (or from the present vehicle's previous traversals of the upcoming road segment), which may be contained in the database information 114. In some implementations, the cloud computing system may be stored locally in the vehicle and may connect to a remote server only sporadically or not at all. The cloud computing system 106 may send (122) the recommended vehicle operating parameter to the vehicle 102. Upon receiving (124) the recommended vehicle operating parameter, the vehicle 102 may initiate (126) a driver alert (e.g., by presenting a graphic on a screen in the vehicle, a heads-up display, via an audible sound, via haptic feedback, etc.) and/or initiate a change in vehicle behavior. In some implementations, initiating a change in vehicle behavior may include, for example, initiating a command at an autonomous driving controller of the vehicle to change a speed of the vehicle. In some implementations, initiating a change in vehicle behavior may include initiating a braking command to slow down the vehicle or limiting power to a propulsion engine or ICE motor.

### Intelligent Speed Adaptation Systems

Current intelligent speed adaptation systems warn or enforce driving speed based on a speed limit and/or driving hazard information (e.g., high pedestrian traffic areas, railway crossings, schools, hospitals, etc.) associated with a road segment. Such speed limit and/or driving hazard information may be sourced from various mapping databases, such as, for example, Open Street Maps (OSM). This speed limit and/or driving hazard information is typically static (i.e., speed limits and locations of schools, hospitals, railways, etc. do not change often) and boundaries may be imprecisely defined.

The inventors have recognized that driving speed recommendations for safety, comfort, and/or vehicle durability may be determined using foresight of one or more upcoming road conditions. In some implementations, upcoming road conditions may be specific to a lane or a track in which a vehicle is traveling on a multilane road. Upcoming road conditions may include, but are not limited to, road events, road roughness, road frequency content, road friction, road curvature, weather dependent events, and/or average driving speed. With precise localization and data sharing with a cloud-based or local database, a recommended driving speed, which may be based on foresight of upcoming road conditions, may be calculated and served to an Intelligent Speed Adaptation system on a vehicle. The Intelligent Speed Adaptation System may be a part of an Advanced Driver Assistance System (ADAS) of the vehicle. The Intelligent Speed Adaptation system then may warn and/or enforce the recommended driving speed to a driver of the vehicle to improve safety, comfort, fuel economy, range, vehicle durability, and/or other desired metrics.

A recommended driving speed calculation may consider upcoming road events including, but not limited to, deep potholes, speed bumps, deep manhole covers, dips, washboards, and/or frost heaves. Driving over these large road events at a speed that is too high or too low may degrade safety, comfort, and/or vehicle durability. Generally, drivers are unaware of upcoming road events in advance and, in some cases, even if the upcoming road event is identified prior to the vehicle traversing the upcoming road event, a driver may not be able to effectively choose a driving speed that will reduce adverse effects on safety, comfort, and/or vehicle durability as the upcoming road event is traversed. For example, a driver may assess a parameter (e.g., depth of a pothole, height of a speed bump, positioning of a pothole, slipperiness of a wet or icy road, etc.) of an upcoming road event too late to adjust a vehicle speed appropriately. A recommended driving speed that may be served to the vehicle and/or the driver of the vehicle prior to traversing the upcoming road event may help a vehicle (e.g., via an autonomous or semi-autonomous driving controller) and/or driver of the vehicle react in a timely manner and adjust driving speed for better safety, comfort, and/or vehicle durability.

A recommended driving speed may be determined in multiple ways. First, a physical model may be used, the physical model being based on road event information contained in road data in a database that may be locally stored on the vehicle or may be retrieved from the cloud at appropriate intervals. The road event information may include an event type (e.g., pothole, speed bump, frost heave, etc.), an event size (e.g., a large event, a medium event, a small event, etc.), an event length, (e.g., a length of a pothole, a length of a speed bump), an event height (e.g., a height of a speed bump, a depth of a pothole, etc.), etc. In some implementations, the road event information may be based on road data that has been normalized by vehicle class (e.g., vehicle characteristics of the vehicle that gathered the data have been removed). In some implementations, road event information may be associated with a class of a vehicle (e.g., sports car, SUV, sedan, etc.) that collected road data contributing to that road event information. In some implementations, a recommended driving speed may be calculated at least partially based on vehicle characteristics of the vehicle that will consume the driving speed recommendation. For example, a sports car with a low ground clearance may receive a different driving speed recommendation than an SUV with a high ground clearance.

Similarly, foresight of road frequency content, road roughness, road friction, road curvature, and weather dependent events (e.g., ice/snow cover and puddles) may be inputs to determining a recommended driving speed. A recommended driving speed takes in foresight of road condition because a vehicle's response (e.g., braking distance, tire grip, handling, traction, etc.) may be significantly different during different weather dependent events. Because vehicle response (e.g., braking distance, tire grip, handling, traction, etc.) may change with varying weather dependent events, a recommended driving speed may change in view of these weather dependent events. The impact of road surface friction (which may change based on the occurrence of weather dependent events) on a recommended driving speed may depend, at least partially, on road characteristics (e.g., road roughness, road frequency content, road friction, road curvature, road slope, etc.) of the road on which the vehicle is traveling. Foresight of these weather dependent events (which are often fast-changing), may be accomplished with precise localization (as described previously) and information sharing between vehicles and a cloud server. A recommended driving speed with road condition foresight may be calculated by using a physical model and/or by using historical vehicle response data from other vehicles traveling at varying driving speeds under the same or effectively the same conditions.

In some implementations, an average driving speed (e.g., an average speed of multiple vehicles traversing the same road segment) may be used to determine a recommended driving speed for a road segment to be recommended by the Intelligent Speed Adaptation System. In one example, if an average driving speed for a specific road segment has dropped (i.e., vehicles have been traveling slower across the road segment) below a certain threshold (e.g., a percentage reduction in speed (e.g., 10%, 20%, 50%, or more reduction in speed) or a particular speed (e.g., 10 mph, 20 mph, 30 mph, 40 mph, 50 mph, etc.), etc.), it may be inferred that there may be an irregular road event (e.g., a road feature, an accident, a weather dependent event (e.g., snow, ice, rain, fog, etc.)) located on the road segment or that there may be slow traffic on that road segment. In such situations, a recommended driving speed may be adjusted accordingly (e.g., to match a recently computed average driving speed).

Referring back to FIG. 1, the system 100 including an Advanced Driver Assistance System (ADAS) configured to operate based on terrain-based insights may include an intelligent speed adaptation system.

In instances where the system 100 includes an intelligent speed adaptation system, the cloud computing system 106 is configured to determine (120), using the road profile 108, and vehicle information 110, a recommended a recommended driving speed for traversing at least a portion of an upcoming road segment or road event. The recommended driving speed may be calculated (120) in the cloud computing system 106 using previous road data (e.g., road condition information, road event information, etc.) from other vehicles that previously drove on the upcoming road segment (or from the present vehicle's previous traversals of the upcoming road segment), which may be contained in the database information 114. In some implementations, the cloud computing system may be stored locally in the vehicle and may connect to a remote server only sporadically or not at all. The recommended driving speed for a specific road condition may be calculated, for example, by using a physical model or from previous vehicle response data from other vehicles or from the same vehicle on the specific road condition as a function of vehicle speed. The cloud computing system 106 may send (122) the recommended driving speed to the vehicle 102. Upon receiving (124) the recommended driving speed, the vehicle 102 may initiate (126) a driver alert (e.g., by presenting a graphic on a screen in the vehicle, a heads-up display, via an audible sound, via haptic feedback, etc.) and/or initiate a change in vehicle behavior. In some implementations, initiating a change in vehicle behavior may include, for example, initiating a command at an autonomous driving controller of the vehicle to change a speed of the vehicle. In some implementations, initiating a change in vehicle behavior may include initiating a braking command to slow down the vehicle or limiting power to a propulsion engine or ICE motor.

Referring to FIG. 2, in scenario 200, a vehicle 202 traveling on a road segment 218 may communicate with a cloud database 206 to determine the vehicle's precise location and receive driver alerts and/or recommendations for operating in an autonomous driving mode. In some cases, the driver may initiate communication with the cloud that the driver is switching to an autonomous mode. The road segment 218 on which the vehicle is traveling may include weather dependent events, such as ice 208 and puddle 210. The road segment 218 may also include a high amplitude input section 212. These road conditions and road events may impact vehicle safety, durability, and comfort as they are traversed. A cloud database, as discussed previously, may include data on these road conditions and road events, which, as previously discussed, may have been sourced from other vehicles, prior trips of the present vehicle, and/or other databases, (e.g., NOAA, etc.).

A terrain-based advanced driver assistance system, as shown and described in FIG. 1 and the accompanying prior text, may have advance knowledge of and/or may predict the existence of these road conditions, and may alert a driver of the vehicle 202 or an autonomous driving controller of the vehicle 202 accordingly. The terrain-based advanced driver assistance system may initiate modification of a driving speed 216, a following distance 214 behind another vehicle 204, and/or another vehicle operating parameter (e.g., initiating a four-wheel driving mode) to improve vehicle safety and/or comfort and/or durability.

Referring to FIG. 3, in scenario 300, a vehicle 302 traveling on a road segment 318 communicates with a cloud database 306 to determine its precise location and receive driver alerts and/or recommendations for operating in an autonomous driving mode. The road segment 318 may include road events, such as speed bump 306, pothole 308, and hill 310. These road events may impact vehicle safety, durability, and comfort as they are traversed. A cloud database, as discussed previously, may include data on these road events, which, as previously discussed, may have been sourced from other vehicles, prior trips of the present vehicle, etc.

A terrain-based advanced driver assistance system may have advance knowledge or and/or may predict the existence of these road conditions and may alert a driver of the vehicle 302 or an autonomous driving controller of the vehicle 302 accordingly. The terrain-based advanced driver assistance system may initiate modification of a driving speed 314, a following distance 312 behind another vehicle 304, and/or another vehicle operating parameter to improve vehicle safety and/or comfort and/or durability.

As an example, as shown in FIG. 4, in scenario 350, a vehicle 352 is traveling on road segment 380 that includes a large pothole 382. In the absence of the terrain-based advanced driver assistance systems described herein providing advanced notice and vehicle operating instructions to one or more vehicle systems and/or an operator the vehicle, the vehicle's response to the pothole may damage tires, rims, and/or other suspension components of the vehicle 352. This damaging impact may occur due to a variety of causes. In some instances, a human or automated operator (e.g., an autonomous or semi-autonomous vehicle controller) may not be able to see the pothole 382 with sufficient warning to be able to reduce speed (or avoid the pothole). In some instances, a human or automated operator (e.g., an autonomous or semi-autonomous vehicle controller) may not be able to correctly judge the severity of the event. In some instances, a human or automated operator (e.g., an autonomous or semi-autonomous vehicle controller) may be forced to reduce or increase vehicle speed at a high rate of deceleration or acceleration in anticipation of the pothole, thus leading to discomfort. In some scenarios, a human or automated operator (e.g., an autonomous or semi-autonomous vehicle controller) may not be able to judge or execute operation of the vehicle within an optimal speed range for traversing the pothole. For example, there may be a speed cutoff below which the vehicle may travel, based on parameters (e.g., ground clearance, tire parameters, etc.) of the vehicle, where traversing the pothole 382 may not cause damage. In another example, there may be a speed cutoff above which the vehicle may travel, based on parameters of the vehicle (e.g., ground clearance, tire parameters, etc.) of the vehicle, where the traversing the pothole may not cause damage due to the vehicle skipping over the pothole at a sufficiently high speed.

The terrain-based advanced driver assistance system of vehicle 352, as shown in FIG. 4 and described herein, may be used to determine an optimal speed range for traversing an event (e.g., pothole 382), and alert (376) the operator or autonomous systems in the vehicle with sufficient time to allow for a smooth deceleration or acceleration to within the target speed range. The optimal speed may for example be determined (370) based on measured vehicle responses for the same vehicle, or other vehicle of similar class, or other vehicles of different classes over the same event, or it may be determined by using models and the road information collected by the same vehicle during a previous traversing of the event, or by other vehicles that traversed the event. The information 364 about the event may be collected in a cloud database or in a local database, may be assembled from multiple drives and/or multiple vehicles, and may be stored on the local vehicle or recalled from the cloud 356 at a time sufficiently ahead of the expected traversal. Steps 354-368 regarding localization of the vehicle are analogous to steps previously discussed in relation to FIG. 1.

### Bridge Recognition and Adjustment

In some instances, such as the implementation shown in FIG. 5, some individual road features may be particularly affected by environmental factors. For example, road surfaces on bridges may ice prior to non-bridge road surfaces in low temperature conditions. In FIG. 5, a vehicle 402 is traveling on a road surface 418 and a portion of the road surface crosses a bridge 412. A cloud computing system 406 may predict the occurrence of a bridge icing event based on, for example, weather information, road profile data, road event information, and/or historic data. Such weather information, road profile data, road event information, and or historic data may be stored in a cloud database 406 (analogous to cloud database 106 including database information 114 in FIG. 1) and may be used as an input to the advanced driver assistance systems using terrain-based insights as described with reference to FIG. 1. If a bridge icing event may be occurring on the bridge 412, a terrain based adaptive cruise control system, a terrain-based collision warning and avoidance system, a terrain-based intelligent speed adaptation system, etc., may alert a driver and/or an autonomous driving controller of the vehicle 402 to increase a safe following distance 410 behind another vehicle 404, change a driving speed 408, and/or change any other appropriate vehicle operating parameter, accordingly.

### Adaptive Cruise Control

In general, adaptive cruise control systems may be configured to control a vehicle to maintain a safe following distance behind another vehicle to allow a driver, or autonomous driving controller, of a vehicle to have enough time to react to incidents on the road without colliding with another vehicle that the vehicle is following. The inventors have recognized that a terrain-based adaptive cruise control system, examples of which are described herein, may implement a safe following distance that is configured to vary based on road conditions (e.g., road friction, road roughness, road frequency content, road curvature, road slope, localized weather, etc.). For example, a braking distance of a vehicle is typically longer on an icy road as compared to a dry asphalt road. Therefore, a safe following distance executed by a terrain-based adaptive cruise control system may be configured to lengthen if the vehicle is traveling on, or will be traveling on, a road segment that is known to be or may be icy. By knowing road conditions on road segments ahead of the vehicle, based on precise localization and data sharing with a cloud computing system, as discussed previously with reference to FIG. 1, an adaptive cruise control system using terrain-based insights may adjust the safe following distance accordingly. In some implementations, a braking distance may be estimated based on past performance of the vehicle. In some implementations, the vehicle's own past performance may be predictive of upcoming performance due to current vehicle parameters being close to previous vehicle parameters. Examples of vehicle parameters include vehicle class, vehicle make/model, tire type, tire wear, tire tread depth, tire inflation level, vehicle weight, brake wear, etc.

Road surface friction may significantly affect braking distance and may, therefore, be an important road condition for determining a safe following distance for an adaptive cruise control system. For example, on snowy surfaces, braking distance may increase by approximately 50% and on icy surfaces, braking distance may increase by approximately 150%. When, based on knowledge of a vehicle's precise location and the road conditions at that location or upcoming locations, a predicted braking distance increases due to reduced road surface friction, a terrain-based adaptive cruise control system may increase the safe following distance before or upon entering a road segment with known or predicted low surface friction.

Generally, road surface friction may be difficult to estimate in real-time under normal driving conditions because excitation (throttling and braking higher than a threshold) is needed to estimate road surface friction accurately. A cloud database may store road surface friction information based on estimations from other vehicles that have traveled over the same road segment and/or a vehicle's own past trips over the road segment. An example is shown in FIG. 1 which includes a cloud computing system 106 including database information 114.

The road surface friction estimations stored in the cloud database may be gathered from multiple sources and in some instances, may be assigned a quality or confidence metric. In some instances, road data from vehicles that performed more aggressive driving behaviors may provide better quality road surface friction estimation. In some instances, aggregation of large amounts of lower quality road surface friction estimations from multiple vehicles performing less aggressive driving behaviors on the same road segment may provide better accuracy road surface friction estimation. In some instances, road surface friction estimations may be measured directly or indirectly from vehicle equipped sensors, including but not limited to optical sensors, acoustic sensors, etc. In some instances, road surface friction estimations may also be created based on models that incorporate information on environmental factors. Environmental factors may include, but are not limited to, atmospheric temperature, road surface temperature, humidity, wind speed, daylight, time, precipitation intensity, accumulative precipitation, road surface water layer thickness, road surface snow layer thickness, road surface ice layer thickness, traffic, road type, road class, road roughness, road slope, etc. In some implementations, one or more sensors for measuring one or more of these environmental factors may be located on the vehicle and data gathered by the one or more sensors may be used to make a road surface friction prediction. In some implementations, one or more sensors for measuring one or more of these environmental factors may be located on other vehicles and data gathered by such other vehicles may be crowd-sourced and incorporated into a database which may be referenced for making a road surface friction prediction. In some implementations, data on one or more environmental factors may be sourced from outside the vehicle and used to make a road surface friction prediction. External sources may include weather or climate information databases (e.g., NOAA databases) which may include current or historical data. In some implementations, road surface friction prediction based on environmental factors may be used when a database is lacking recent high confidence surface friction estimation from drives over a road segment.

Weather dependent single events such as snow cover and puddles may create slippery areas on the road surface that may affect braking distance significantly. A cloud computing system may predict the occurrence of these weather dependent single events based on weather information, road profile information, and/or historical data. If these weather dependent single events are predicted to occur in an upcoming road segment, a terrain based adaptive cruise control system may, for example, increase a safe following distance, reduce speed, limit vehicle excitation, etc., accordingly.

Severe localized weather, such as fog, heavy rain, and/or a snow squall, may significantly affect visibility. In such instances, a cloud computing system may provide information of upcoming localized weather based on precise localization. A terrain-based adaptive cruise system may, for example, increase follow distance, reduce maximum driving speed, for upcoming severe localized weather to minimize effect of degraded visibility. In some implementations, instances of severe localized weather may also cause the system to initiate turning on fog lights.

Road frequency content and road roughness may affect braking distance and driver behavior. For example, when a road is rough and has a high amplitude of input content, braking distance may increase due to tire bouncing (i.e., braking does not occur when the tire and the road surface are not in contact). Also, generally, drivers tend to decelerate rapidly on road sections with such characteristics. If the upcoming road surface is rough and has a high amplitude of input content, a terrain based adaptive cruise control may, for example, increase a safe following distance, reduce maximum speed, reduce driving speed, etc., accordingly.

Terrain-based adaptive cruise control may increase following distance to enhance safety when upcoming road curvature is steep and/or when upcoming road slope is steep. In such situations, another vehicle in front of the vehicle may be expected to decelerate rapidly. Also, a radar of the adaptive cruise control system may more easily lose track of the other vehicle during steep road curvature and/or steep road slope.

Referring to FIG. 6, a method 450 for determining a following distance for an adaptive cruise control system of a vehicle is shown. The method includes obtaining (452), by one or more sensors of the vehicle, road data of a road segment on which the vehicle is traveling, determining (454), based on the road data, a current road profile of the road segment, sending (456), to a cloud database, the current road profile, receiving (458), from the cloud database, a set of candidate stored road profiles, determining (460), by a processor, a location of the vehicle based on the set of candidate stored road profiles and the current road profile, and determining (462), by the processor, the following distance, the following distance being based, at least partially, on the location of the vehicle. Many steps of this method may be mirrored in the flow chart of FIG. 1 and its accompanying description.

### Collision Warning and Avoidance and Automatic Emergency Braking and Steering

In general, Collision Warning and Avoidance systems, which may include for example Forward Collision Warning, Automatic Emergency Braking, and Automatic Emergency Braking and Steering, detect an imminent collision and attempt to eliminate or mitigate the effects of an imminent collision. Attempting to mitigate or eliminate an imminent collision may include warning (via a visual, audible, haptic, and/or other alert) a driver of the vehicle to brake, autonomously performing emergency braking, and/or autonomously perform steering to avoid the collision.

The inventors have recognized that foresight of lane or track specific road conditions of upcoming road segments, including but not limited to road surface friction, road frequency content, road roughness, road events, and weather dependent events, a terrain-based collision warning and avoidance system may estimate braking distance more accurately than traditional systems. A terrain-based collision warning and avoidance system may therefore adjust warning trigger points and/or automatic braking trigger points according to these more accurate braking distance predictions and provide alerts tailored to the vehicle's precise location. Foresight of road conditions of the vehicle's current lane and any adjacent lane(s) may also help in deciding between using automatic emergency braking, automatic emergency steering, or both when a potential collision is predicted.

By knowing or making an accurate prediction of road surface friction of the vehicle's current lane and one or more adjacent lanes of an upcoming road, Collision Warning and Avoidance system may improve warning timing, braking trigger timing, and accuracy of deciding between automatic emergency braking and automatic emergency steering. For example, if an adjacent lane has a higher surface friction than the current lane of travel (e.g., by an amount greater than a predetermined threshold, etc.), a terrain-based collision warning and avoidance system may prioritize an operating mode that would avoid a collision by steering into the adjacent lane (assuming that the adjacent lane is open, which may be determined in some instances by on-board vehicle sensors) as compared to an operating mode that would perform emergency braking on the current, lower surface friction lane. The road surface friction estimation may be based on recent driving data from other vehicles recently having traveled on the specific lane of the upcoming road segment from other vehicles, and/or from prediction with model built from weather nowcast information, information on environmental factors, and/or historical data, or any combination thereof. Driving data from other vehicles may be estimated from vehicle dynamics data, measured from one or more on-board vehicle sensors, etc.

In some implementations, a terrain-based Collision Warning and Avoidance system may be configured to assume high road surface friction to minimize the system false trigger rate. In such implementations, road surface friction estimations for upcoming road segments may be provided together with a confidence level of such estimations. Therefore, in some implementations, the Collision Warning and Avoidance system may be configured to adjust a warning timing, a warning type, and/or an action trigger timing based on a road surface friction estimation only when the confidence level of the estimation is higher than a threshold. In some implementations, the Collision Warning and Avoidance system may adjust a warning timing, a warning type, and/or an action trigger timing according to the combinations of road surface friction estimation and the confidence level of the estimation, to minimize the false trigger rate while avoiding collisions in low road surface friction conditions.

In some implementations, the Collision Warning and Avoidance system may be configured to assume low road surface friction to default to acting earlier and may therefore potentially avoid more collisions. Such Collision Warning and Avoidance systems may also adjust warning and/or action trigger timing based on combinations of road surface friction estimations and the confidence level of such estimations, to avoid collisions while also reducing false trigger rate.

In some scenarios, upcoming road segments may include mixes of surface conditions. For example, there may be wet, slushy, snowy, and icy road conditions mix in the same road segment in the same lane in wintertime, especially after multiple vehicles have traversed the same lane. In such scenarios, the actual road surface friction of the road segment will not be a single value. In these scenarios, the road surface friction estimations from vehicle driving on such road segment may have large variance as the estimation values would depend on which condition (wet, slushy, snowy, icy, etc.) on the road segment the vehicle generating the estimation traversed. In this case, some smart clustering methods designed with confidence level of road surface friction estimations may be used to predict the highest and lowest road surface friction values of the mix conditions. In some implementations, a terrain-based Collision Warning and Avoidance system may be configured to act based on a lowest road friction, a highest road friction estimation, an average road friction estimation, or any other appropriate metric determined based on the varying data collected. The confidence level of the estimations in these scenarios may be lowered to indicate uncertainty of which surface condition the surface of the road segment is experiencing as the current vehicle traverses the road segment.

Besides road surface friction, weather dependent single events such as snow cover, ice formation, and puddle formation, which may create slippery patches, road frequency content, and road roughness all may be lane specific road conditions that may affect braking distance. Foresight of such road conditions of upcoming road segments may help the Collision Warning and Avoidance system make better decision to enhance safety of the vehicle.

Referring back to FIG. 1, a process of communicating between a vehicle 102 and a cloud computing system 106 may be used to determine if an appropriate vehicle has terrain-based localization that may be used to determine a precise location of the vehicle. As the vehicle travels, the vehicle may report its location and upload a road condition estimation (and/or road data that may be used to determine such an estimation) of the road segment that the vehicle traversed to the server. The server may transmit the lane specific upcoming road condition prediction to the vehicle based on estimation from another vehicle which recently drove on upcoming road, and/or based on predictive model using weather data and environmental factors data, and/or based on historical data from other vehicles gathered under similar conditions. The Collision Warning and Avoidance system may then estimate, for example, braking distance based on road condition foresight and/or adjust the system trigger point and decision making accordingly to enhance safety. For example, if foresight of low friction surface on upcoming road is determined, the system may also determine that braking distance is going to increase. The system may then adjust system trigger point to warn the driver or engage automatic braking earlier before entering low friction surface section, to avoid collision or reduce collision impact even with longer braking distance when an emergency occurs. The system may reset the vehicle to a normal driving mode after the vehicle has completed traversing the low surface friction section.

Referring to FIG. 7, a method 480 for determining an automatic emergency braking trigger point distance for a vehicle is shown. The method 480 includes obtaining (482), by one or more sensors of the vehicle, road data of a road segment on which the vehicle is traveling, determining (484) based on the road data, a current road profile of the road segment, sending (486), to a cloud database, the current road profile, receiving (488), from the cloud database, a set of candidate stored road profiles, determining (490), by a processor, a location of the vehicle based on the set of candidate stored road profiles and the current road profile, determining (492), by the processor, the automatic emergency braking trigger point distance, the automatic emergency braking trigger point distance being based, at least partially, on the location of the vehicle, and initiating (494), when the vehicle is within the automatic emergency braking trigger point distance from another vehicle or object, via an advanced driver assistance system of the vehicle, an alert to a driver to brake.

### Lane Keep Assist Systems

Advanced driver assistance systems (ADAS) in today's vehicles enhance a driver's ability to steer the vehicle to remain within a lane and avoid encroaching on adjacent lanes of travel on roadways (both lanes of travel intended for same direction and opposite direction travel). This safety feature commonly relies on vision-based sensor systems like forward and sideways-facing cameras to identify lane markers and determine an appropriate path to take to remain within the lane.

The sensor systems used for this application are vulnerable to multiple potential failures, including sensor obscurement through reflections or dirt on the glass; sensor function reduction due to environmental conditions such as rain, fog, snow and/or other materials covering the roadway and/or the sensors; and a possible general inability to identify lane markers due either to an absence of markers, or a poor quality of the lane markers themselves, or due to obscurement of the lane markers through interference, occlusion, or lighting problems such as darkness. Such obscurement and/or inability to identify lane markers leads to the lane keep assist system being unable to function (e.g., being unable to provide lane keep assist instructions), or in some scenarios, being prone to misidentification errors, which may lead to incorrect lane keep commands being instructed.

The inventors have recognized that using additional inputs may enhance the function of such lane keep assist systems. In some implementations, a high-definition map may be used, where the high-definition map contains details related to the road such as for example the terrain profile, road events, road content, and/or similar road characterization features; road signs and other distinctive landmarks in the vehicle's surroundings; mean, median, and/or typical heading; curvature, and/or path of previous drives; or any subset thereof, in addition to many other possible details. In some implementations, a database of such road-related information (e.g., the cloud computing system 106 including database information 114 shown in FIG. 1) may be considered a high-definition map. In some implementations, this high-definition map may include crowd-sourced information sourced by gathering data from other vehicles and/or from previous drives.

As described previously, an accurate estimate of a vehicle's current position may be made, for example using terrain-matching of road features, road profile information, and/or events from the high-definition map. In some implementations, an accurate estimate of a vehicle's current position may be mad using feature matching for landmarks in the road profile or the environment, and/or using high precision global navigation system signals in addition to or in place of terrain-based localization.

Once a precise location is known, and given the typical path driven by other vehicles traversing the road segment, this information may be used to determine undesired deviations from the typical path by the current vehicle. In some implementations, a determination by the terrain-based localization system that the vehicle has deviated from the typical path may be used as an additional input into the lane keep assist system. Such an input may be in the form of an error signal fed to the control system, in the form of a reference signal used to identify faults in the control system, or in the form of a warning to the driver or operator through tactile or visual cues such as for example a heads-up display or a modification of the steering effort torque felt by the driver.

In some implementations, the system may recognize the presence of features in the travel lane that one might want to avoid, such as for example large potholes, sections of low friction road surface, truck ruts, etc. These features may be derived from a high-definition map, for example a crowd sourced road map or a map built through computer vision analysis of street-level images or a map derived from other unrelated sources, or they may be inferred from past driving data in the same vehicle, or any combination thereof.

Given a precise location of the vehicle and a known location of road features (e.g., road events, road conditions, etc.) to be avoided on a given road segment, the system decides how to act. If for example the road feature is small in the lateral direction (the direction normal to the general travel direction), then a recommendation to the steering system may be made to deviate the target path from the intended path to avoid the feature. This desired deviation is weighed against safety considerations, for example related to the width of the lane and the presence of other vehicles nearby, and is then used as an input, if appropriate, to calculate a new desired path. For example, if a small but deep pothole is present in the lane and is in line with one set of tires (right or left side of the vehicle) when the vehicle is driving in the center of the lane, then an offset may be commanded to shift the vehicle toward one side or the other depending on safety considerations (for example the presence or absence of an additional travel lane to each side) over a safe period of time, for example 5 seconds or more, and the vehicle may avoid the obstacle for example by simply driving such that the wheels straddle the obstacle, or by driving such that the obstacle is left to one side or the other of the vehicle. In some instances, when the feature cannot be avoided, the system may recommend a speed for interacting with the feature (e.g., a reduced speed, an increased speed, etc.).

The location of a road event in a lane may be determined using a terrain-based localization system that employs a clustering method, as described previously. Individual lanes of travel may contain multiple tracks within them, and an event may exist on one or more of these tracks. In some instances, the cloud database may understand the spatial orientation of the tracks in relation to one another. A terrain-based lane keep assist or path planning system may employ this information to recommend that a vehicle switch tracks to avoid an event located on one track that is not located on another.

Depending on the level of autonomous driving capability present and engaged in the vehicle at that time, the system may intervene to steer the vehicle, may provide tactile or audible feedback to the driver or operator, or may alert the driver or operator through visual cues such as an indication on a heads-up display. This may be useful even in driving situations where the vehicle is being driven by a human operator, as road features may often be seen too late to properly respond (for example due to vehicles in front obstructing them) or not evaluated accurately (for example a pothole may be mis-judged as being shallow when it really is deep).

In some implementations, the map detail and location information as described above may be used to help decide what travel lane is best, for example at a given speed or under certain weather conditions. As an example, one or more road features may be present in one lane or track on a multi-lane road, and this information, along with information about the current location of the vehicle, may be used to recommend avoiding a particular lane or track of travel.

In some implementations, this information may be relayed to a path planning component of an autonomous or partially autonomous vehicle and the vehicle may attempt to change lanes ahead of the indicated section as long as it is safely able to do so. In another implementation, the information may be relayed to the human operator in the form of visual (e.g., a heads-up display, a navigation display, etc.), tactile (e.g., steering wheel torque feedback, haptic vibration feedback), and/or audible (e.g., directional warning sound) cues, allowing the operator to select a course of action. In another implementation, the upcoming road content in each of the travel lanes on a multi-lane road may be categorized and analyzed. For example, a vehicle may be more inclined to causing uncomfortable motions, or motions that have a propensity to cause motion sickness, or motions that are more likely to damage the vehicle or its components, on roads with a certain type of content. This content may be qualified by analyzing past drives of the same vehicle, or a vehicle of the same type or category, against metrics relating to comfort, motion sickness, or damage propensity, and an analysis of upcoming road segments at any given travel speed may then be used to select the best lane to drive in. This information is then provided to the path planning component of the autonomous system, or to the human operator in the form of visual, tactile, or audible cues.

Referring to FIG. 8., a driving scenario 500 shows a vehicle 502 traveling on a roadway 504 in lane 506. The vehicle 502 has a left wheel 510 and a right wheel 512. Feature 516 is recognized as being in the path 514 of the vehicle 502. Specifically, the right wheel 512 is anticipated to impact the feature 516 if the vehicle 502 continues along the path 514. With this knowledge, a path controller 518 of the vehicle 502 may modify the path 514 so that the anticipated impact between the right wheel 512 and feature 516 does not occur. The modified path may move the vehicle into another lane (e.g., lane 508) or may keep the vehicle within the lane 506. Both of these scenarios are illustrated and described herein.

Referring to FIG. 9, in scenario 600, a terrain-based lane keep assist system initiates a command or a recommendation that the vehicle 502 move along path 620 to straddle the feature 516 in the roadway 504 without leaving the travel lane 506. The command may be an input to the path planning controller 518 or a recommendation or suggestion (e.g., via visual cues, audio cues, heads-up display instructions, tactile alerts, etc.) to the operator of the vehicle 502.

Referring to FIG. 10, in scenario 700, a terrain-based lane keep assist system of a vehicle 502 initiates a command or a recommendation that the vehicle 502 move along path 720 to navigate around the feature 516 in the roadway 504. Taking the path 720 causes the vehicle 502 to deviate from the current travel lane 506 into an adjacent travel lane 508 in the same travel direction. The command may be an input to the path planning controller 518 or a recommendation or suggestion (via visual cues, audio cues, heads-up display instructions, tactile alerts, etc.) to the operator of the vehicle 502. The vehicle 502 may continue traveling in the adjacent travel lane 508 or may change back into lane 506 after the feature 516 has been navigated around.

Referring to FIG. 11, a method 750 for calculating a target travel path for use by a lane keep assist system, the travel path being for a first vehicle traversing a road segment. The method includes determining (752) a current location of a first vehicle, obtaining (754) a target travel path for traversing the road segment based at least in part on the current location of the first vehicle, and determining (756) an error between the current location of the first vehicle and the target travel path.

### Autonomous Driving Trajectory Planning

Advanced driver assistance systems (ADAS) in vehicles enhance the driver's ability to steer the vehicle to remain within a lane and avoid encroaching on adjacent lanes of travel on roadways (both lanes of travel intended for same direction and opposite direction travel). This safety feature commonly relies on vision-based sensor systems like forward and sideways-facing cameras to identify lane markers and determine an appropriate path to take to remain within the lane.

Sensor systems used for this application may be vulnerable to multiple potential failures, including sensor obscurement through reflections or contamination of the sensor (e.g. dirt); sensor performance degradation due to environmental causes such as rain, fog, snow or other materials covering the roadway; and a possible general inability to identify lane markers due either to an absence thereof or a poor quality of the lane markers themselves, or due to obscurement of the lane markers through interference, occlusion, or lighting problems such as darkness. Such obscurement and/or inability to identify lane markers leads to the lane keep assist system being unable to function (e.g., being unable to provide lane keep assist instructions), or in some scenarios, being prone to misidentification errors, which may lead to incorrect trajectories being planned and/or instructed.

The inventors have recognized that by using precise localization and one or more trajectory paths from previous drives to provide an added error signal to the path planning controller or to the human operator, the impact of sensor failure on providing driver assistance may be decreased. A terrain-based advanced driver assistance system may provide a warning to an autonomous driving trajectory planning system if a commanded trajectory deviates from a typical driving path. A typical driving path may be, for example, a driving path that is commonly traversed on the road segment based on crowd-sourced data.

The inventors have recognized that compensation for sensor failures may be accomplished in multiple ways, for example by 1) having advance knowledge of the desired path based on a high-definition map or 2) by using information based on previous drives in the same vehicle along the desired path or based on previous drives in at least one different vehicle along the desired path. This information may for example be the precise location of the driven and/or other vehicles, and/or may be a location in combination with a heading of the driven and/or other vehicles, and/or may be information from a vision-based sensor or other sensor that is able to detect location in relation to landmarks such as lane markers, road delimiters, and/or buildings nearby. From these sources, a desired path may be derived, for example by calculating an average path from a multitude of drives, or by using a path from a reference drive that was either created for the specific purpose of mapping or was deemed accurate enough based on reference criteria. An average calculation may, for example, include removing outliers, and may remove vehicles measuring high rates of change in heading over any given segment. The average calculation may also include accounting for the speed of each vehicle and weigh drives at abnormally high or low speed differently and may also take into account speed and vehicle type to calculate multiple paths that are each appropriate for a given speed range, vehicle type, a combination thereof, and/or other factors. Any of these factors may be included and used to create a desired reference path for the vehicle driving a given road.

An accurate localization system may be used to determine the current position of the vehicle along the road. This accurate system may use several technologies, for example global navigation system satellites, real-time kinematic corrections from a base station, and similar technologies known in the industry that are able to create a precise localization service; as another example they might use dead reckoning based on vehicle-based motion sensors such as an inertial measurement unit, or a combination of global navigation system satellites and dead reckoning techniques, for example blended using a Kalman filter; as yet another example they might use terrain-based localization services that recognize features or components of the road or surroundings, such as for example vision-based event recognition of buildings, trees, signs and other features, sensor-based recognition of road features or events, or ground-penetrating laser enabling recognition of road substrate composition. Many other localization systems are understood to be useful. Greater accuracy in the localization enables better functionality of the systems described herein, especially along the direction of travel. In some instances, a localization accuracy of less than 1 m, but preferably less than 20 cm in the direction of travel and along the road surface may be employed, while an accuracy of less than 5 m, but preferably less than 1 m, may be employed in the direction normal to the direction of travel of the vehicle.

Typical advanced driver assistance systems use multiple sensors to determine if a correction should be made to the current path. Under ideal circumstances, a lane marker may be recognized on either side of the vehicle and a path may be calculated to be close to the same distance away from both, in order to travel in the center of the marked lane. The inventors have recognized that this method of determining a path may be problematic, for example when at least one lane marker is not visible or is poorly marked, or for example in the very common scenario shown in FIG. 13, where an exit lane 908 branches off the main travel lane 906, and the lane markings on one side of the road follow the exit lane. In this scenario, a calculated center between the two-lane markings on each side of the vehicle would appear to veer partially into the exit lane, before snapping back into the travel lane abruptly where the exit lane departs the roadway.

In these and other special cases, where the lane markings alone are not sufficient to plan a trajectory for the vehicle, a desired trajectory may be derived by a terrain-based autonomous driving trajectory planning system using the high-definition map (which includes including road surface information as described above), along with the precise location of the vehicle as described above. The terrain-based autonomous driving trajectory planning system may calculate an error between a trajectory indicated by the vision-based system and a trajectory determined based on information contained in the high-definition map. This error may be used in multiple ways. For example, in situations where there is high confidence in the road information contained in the high-definition map, due to , for example, the existence of data from many previous drives, or low confidence in the visual data, for example due to weather conditions, sensor obscurement, etc., the trajectory determined based on the road information data in the high-definition map may be used as a replacement, thus applying all of the calculated error as a correction to the original command. If, on the other hand, the confidence in the high-definition map data is low or there are no indications of problems with the vision data, a more cautious approach may be warranted where either only part of the error or none of the error is applied as a correction signal. The decision of weighting or selecting a source of trajectory planning data, whether visual, terrain-based, or some combination of the two, may be made, for example, by the trajectory planning controller. The trajectory planning controller may be a component of an autonomous or a semi-autonomous driving system of the vehicle. In one implementation, the trajectory planning controller may calculate the error and look for large discrepancies. In instances of such discrepancies, the trajectory planning controller may execute instructions to may warn the driver of these discrepancies (e.g., by initiating an audible, visual, haptic, and/or another alert) and may turn off automatic steering and/or other autonomous driving features if the discrepancy is high and cannot be explained through sensor fusion or other signals.

Referring to FIG. 12, in scenario 800, a vehicle 802 is traveling along a measured path 810 in lane 806 of roadway 804. The measured path 810 is determined, by a controller 808, to be offset from a desired path 812 by offset 814. The controller 808 may initiate a command or a recommendation to an operator to correct the vehicle's path so that the vehicle follows path 812. For example, in some implementations, the controller may initiate an alert (e.g., an audio, visual, and/or tactile alert) to a driver of the vehicle 502 to steer to the vehicle toward the desired path 812.

Referring to FIG. 13, in scenario 900, a vehicle 902 approaches a split in the roadway 904 where a first lane 906 proceeds straight and a second lane 908 (which may be, for example, an exit lane) splits off to the right from the first lane 906. In some trajectory planning control schemes, a controller 918 may calculate a desired path as being the same distance from lane markings on the left and right sides of a lane in which a vehicle is traveling. If such a control scheme is used, as the vehicle 902 approaches the split in the roadway 904, the controller 918 may calculate pathway 914 as the desired path for the vehicle 902. However, this path 914 would cause the vehicle 902 to operate along a trajectory which does not match a lane (either first lane 906 or second lane 908) of the roadway 904 and may result in a dangerous situation for the vehicle as it veers off the travel lane.

In a terrain-based trajectory planning system, a cloud computing system 916, which includes a cloud database that may be locally stored on the vehicle or may be remotely located and accessed at appropriate intervals through an over-the-air connection, may provide the vehicle 902 with terrain-based information. For example, when the vehicle 902 approaches the split in the roadway 904 and begins to take path 914, the cloud computing system may recognize that a road profile (derived from road data gathered by vehicle sensors (e.g., accelerometers)) corresponding to path 914 does not match any valid road profile (e.g., road profiles corresponding with proceeding straight along path 910 in lane 906 or taking the exit lane 908 along path 912) for the area in which the vehicle is traveling. In such situations, the controller 918 may steer the vehicle to bring the vehicle back to traveling on either path 910 or path 912, may alert a driver of the vehicle (e.g., via a visual, an audio, or a tactile alert), and/or may apply the brakes to reduce travel speed and thus decrease the potential for harm.

In some implementations, a terrain-based trajectory planning system may choose paths that reduce sharpness and/or improve comfort for occupants of the vehicle. Referring to FIG. 14, a vehicle 1002 approaches a turn on roadway 1004, where keeping the vehicle at an equal distance between line markings on either side of lane 1006 would cause the vehicle 1002 to take a sharp turn along path 1008. The terrain-based trajectory planning system may instead communicate with a cloud computing system 1016 to receive information on a typical path 1010 driven by a human operator through the turn and how far off of the typical path 1010 the vehicle 1012 is currently traveling. A controller 1018 may initiate a command to steer the vehicle 1002 to move the vehicle 1002 onto path 1010 and/or may alert a driver of the vehicle (e.g., via a visual, an audio, or a tactile alert).

Referring to FIG. 15, the flow chart 1050 illustrates a method for calculating a target travel path for a first vehicle traversing a road segment, the vehicle having a terrain-based trajectory planning system. The method includes determining (1052) a current location of a first vehicle, obtaining (1054) a target travel path for traversing the road segment based at least in part on the current location of the first vehicle, and determining (1056) an error between the current location of the first vehicle and the target travel path. The method also includes comparing (1058) the error to a threshold and determining that a current path of the first vehicle is not appropriate for traversing the road segment. The method also includes calculating (1060), based on the error, a corrective action to bring the current trajectory to match the target travel path. In some instances, the method also includes initiating the corrective action with an advanced driver assistance system of the first vehicle that at least partially influences the steering of the first vehicle.

### Adaptive Headlights

Modern road vehicles have headlights configured to illuminate the road ahead of the vehicle. It is generally true that illuminating the as much of the road ahead of the vehicle as possible is beneficial to the operator of the vehicle, provided that the light source (i.e., the headlamps) is sufficiently strong. However, illuminating the road far ahead of the vehicle though may also have a negative impact, because the headlights will then also shine strong light onto oncoming vehicles, potentially obstructing the visibility of operators of such vehicles. For this reason, maximum allowed headlight angles are generally regulated by authorities such as local departments of motor vehicles. A challenge is however introduced by the fact that weight changes in the vehicle may lead to the vehicle pitching up or down and thus to a change in the headlight angle with respect to the road. In some localities, adaptive systems that control for pitch changes in the vehicle above the road and maintain a maximum allowable headlight angle are also mandated. Another problem occurs when a vehicle is rounding a turn and the headlights are illuminating the section of road (or a non-road area) straight ahead of the vehicle and not the section of road which the vehicle is about to traverse.

Some vehicle makers have begun using headlights with the ability to change the angle of their light beam from left to right and/or up and down. This may be done in multiple ways, for example including using an actuator system to move the headlight, headlight assembly, lenses, or reflectors that direct the light beam, or by using a plurality of light sources, each illuminating at least partially toward a different direction and engaging them selectively as desired. The selection of the desired angle may be guided at least in part by looking at a projected trajectory of the vehicle, using for example a model based on steering angle, speed, yaw rate and/or lateral acceleration measurements and/or model states, for example using a bicycle model or a Kalman filter. The selection may also be guided at least partially by using a predicted path based on map data, for example by using a navigation input and a map layer to predict upcoming curvature. The selection may also be at least partially guided by sensors that detect road path changes, for example cameras or LiDAR systems. The selection may also be at least partially guided by sensors that indirectly or directly measure the position of the vehicle with respect to the road. The selection may also be at least partially guided by sensors that detect oncoming traffic to allow lowering or appropriately directing the light beam such as to avoid interfering with the operators of the oncoming vehicles.

When driving on a road with significant elevation change, the headlights may only illuminate parts of the road ahead of the vehicle. For example, when driving on a road that rises in front of the vehicle, the headlights may illuminate a section of road that is closer to the vehicle and potentially smaller than if the road were flat (see, for example, the illustrations of FIGS. 16 and 17). When driving on a road that falls away in front of the vehicle, the headlights may illuminate a section of road that is farther in front of the vehicle and potentially larger, but also may potentially illuminate oncoming vehicles in an undesired manner. Even using headlight systems described above (e.g., actuating the headlight beams mechanically up or down or side to side, changing the vertical and/or lateral angle of the light beam by selectively turning individual light sources on and off, etc.) this problem persists, as the road ahead of the vehicle is not known and can, generally, not be sufficiently sensed with existing sensor systems such as vision-based systems, LiDAR, radar, or other known technologies.

The inventors have recognized that terrain-based advanced driver assistance systems (terrain-based ADAS) may employ knowledge of or make a prediction based on terrain-based road information (e.g., a road profile, road event information, etc.) ahead of the vehicle. This terrain-based road information may include, for example road elevation change and/or the road curvature. Using a method to supply this information to the vehicle with enough advance notice, a vehicle controller may request an actuation of the headlight mechanism, or a change in the headlight illumination pattern based on the terrain-based road information.

In some implementations, a vehicle approaching a hill may receive road elevation information from a road preview system. A calculation may be made as to the current angle of the vehicle with respect to the upcoming road by projecting the slope of the road under the vehicle (as provided by a road preview elevation map and knowing the precise location of the vehicle or as provided by a sensor installed on the vehicle) forward to calculate its intercept with the roadway ahead of the vehicle. Keeping in mind that there may be multiple intercepts due to the road contour, which may be known as a portion of the terrain-based road information, a calculation may be made as to the optimal angle of the headlights with respect to the vehicle itself. An optimal angle might for example be calculated by establishing a priori a desired maximum distance in front of the vehicle to be illuminated, or a desired minimum distance, or both, and then comparing the distances expected with a given road elevation profile and vehicle angle at any given moment. An optimal angle might also be calculated by determining a desired length of roadway to be illuminated, or other parameters about the illumination provided by the headlights and comparing this to the expected result on a given roadway. It should be noted that this optimal angle may depend on factors such as the vehicle speed and the vehicle type, and on the presence or absence of oncoming traffic.

In some implementations, an assumption may be made that the vehicle elevation angle is close to the slope of the roadway, for example on average within 1 degree, and thus an angle of the vehicle may be calculated for all upcoming road segments that are provided to the vehicle, thus allowing this calculation to be performed sufficiently ahead of time to allow time to actuate the headlights. In this context, a vehicle elevation angle may be understood to be the angle between a line connecting a point on the front of the vehicle chassis and a point on the rear of the vehicle chassis, and a line representing level ground. It should also be understood that in this definition, an absolute reference value may be set by the designers of the vehicle to define an elevation angle of zero to be such that the vehicle is at that angle when loaded to its design operating weight and standing still on level ground. In that manner, a typical elevation angle of the vehicle when travelling on a roadway will be near the reference value unless the roadway is not level. An elevation angle defined in this manner may be calculated for example by comparing a front and rear suspension height sensor reading and subtracting the values measured at the reference position when standing still on level ground. An elevation angle defined in this manner may also for example be inferred by measuring the current relative heights of the front and rear of the vehicle with respect to a pre-defined reference position (e.g., a mid-point of suspension travel or another point defined by the vehicle designers, or a point defined during operation based on current conditions), for example using ride height sensors on at least one front and one rear suspension link.

In some implementations, the calculation of the effects of headlight angle changes, or illumination pattern changes, may be predicted more effectively based on knowledge of a particular vehicles' headlight function. Many vehicles, for example, use high beam headlights that have a focused beam, thus strongly illuminating some areas ahead and to the side while poorly illuminating others, while other vehicle might have less clearly defined cones of illumination. In either case, the method described herein creates a definition or mapping of what is declared as illuminated at a given headlight angle or pattern. This definition or mapping may also be adaptive and use sensor feedback to modify its functionality.

Actuation of headlights may be varied. Some headlight systems use mechanical actuators to move beams or reflectors up and down and side to side. These mechanical actuators may be fairly slow and operate in a matter of 1 second, 0.5 seconds, etc. In some modern vehicles, the mechanical actuators may operate in less than half a second. Other headlight systems use multiple light sources, for example multiple LEDs, and have control systems enabling a change in which light sources are illuminated at any given time. A simple example of this is a high beam/low beam setup that is common in most vehicles, where the illuminated area in front of the vehicle may be modified quickly. Another example includes laterally positioned headlamps or LEDs that are configured to illuminate the road in the direction of a turn.

As an example, a vehicle may receive elevation information for a long stretch of road ahead and desire to illuminate up to 100 m in front of the vehicle at the current driving speed. Using the road elevation profile, a calculation may be made of the vehicle angle at any given point along that road, and the angle of the headlights with respect to the vehicle may be determined in order to meet the desired illuminated distance. A headlight angle command sequence may be created. The vehicle's location may be estimated based on sensors (for example GNSS or LiDAR, radar, or others), based on map matching of features, and/or based on any other appropriate method. Given the current location along the headlight angle command sequence, a prediction as to when to command the next headlight angle or headlight pattern based on the known functionality of the headlight system, or based on a model thereof, may be made. For example, for a headlight with a known delay in actuation function, this delay could be considered when commanding the motion, for example by commanding the motion ahead of when it is needed.

Other factors may be considered at the time of actuation of the headlights, such as for example the presence of a vehicle in the oncoming traffic lane (which may for example be sensed by a light sensor) and the vehicle speed, personalized settings, the type of roadway, and others. The output may be a command to the headlight system to adjust the beam location, intensity, or both as appropriate, or may be an indication to the operator to adjust settings, for example in the form of a high beam adjustment warning on a heads-up display or dashboard.

In some implementations, a similar decision may be made for road elevation changes that cause the ground to dip away, where it may be preferable to illuminate the road at a more downward angle, for example to allow improved visibility once the vehicle crests a hill. Other examples include road content such as bumps that may require a stronger illumination or a wider cone of light to provide optimal visibility to the operator; uneven road content on one side versus the other side of the road that may require individual headlight angle adjustments; road curvature changes that may be better illuminated by light sources pointing toward the road rather than in the direction the vehicle is heading; and others.

The challenge of illuminating the path ahead in a turn is, in some modern vehicles, addressed by using the vehicle's steering angle and speed to indicate a turn and consequently either engaging additional light sources in the direction of the turn, or rotating the headlight beam into the direction of the turn. This has the disadvantage that the light only illuminates the upcoming road segment once the steering wheel is turned, but also the disadvantage that it may only respond to the steering input and not to the actual road ahead, such that the operator will not see the road curving until they initiate a turning maneuver, but they may not initiate a turning maneuver if they do not see the road curving. With terrain-based ADAS, as described herein, a predicted direction from a terrain-based preview map would enable an optimal light beam direction to be determined for an upcoming road segment. In some implementations, a driver's intention may be considered alongside of terrain-based information on the upcoming road segment. For example, if the driver intends to steer toward an edge of the road (which may be determined based on known past trajectories, track direction, etc. from the terrain-based road information) the light beam is not only directed toward the road's direction, but also specifically illuminates the path the driver desires to take. This decision may be made based on safety criteria that enables optimal operation and may consider speed, steering angle and steering angle rate, and a model of typical and extreme maneuvers to allow the best choice. A possible implementation of this system may include at least partially illuminating in the direction the vehicle is heading, but also or preferentially illuminating a direction of the roadway.

Referring to FIG. 16, in scenario 1100, a vehicle 1102 is traveling along a road surface 1104. The headlights (see, e.g., headlight 1106) of the vehicle 1104 create an area of light 1108 that illuminates a stretch of road 1110 ahead of the vehicle 1102.

Referring to FIG. 17, in scenario 1200, a vehicle 1202 is traveling along a road surface 1204 that has an elevation change (e.g., hill 1212) in front of the vehicle 1202. The headlights (see, e.g., headlight 1206) create an area of light 1208 that, due to the elevation change in the terrain, illuminates only a small stretch of road 1210 that is closer to the vehicle than if the vehicle 1202 had been traveling on a flat road surface.

Referring to FIG. 18, in scenario 1300, the vehicle 1200 approaches the same hill 1212 as shown in FIG. 17. However, with advance knowledge of the road surface 1204 (including elevation change indicating hill 1212 exists), the headlights (e.g., headlight 1206) have been adjusted to create an area of light 1302 that is pointing higher than the normal position (see, e.g., area of light 1208 in FIG. 17). As such, a stretch of road 1304 that is illuminated by the area of light 1302 includes a larger portion of road segment 1204 that is further ahead of the vehicle 1202 than the stretch of road 1210 illuminated by area of light 1208 in FIG. 17.

Referring to FIG. 19, the flowchart shows a method 1350 for providing terrain-based insights to an adaptive headlight system of a vehicle. The method includes obtaining (1352) road surface information of a road segment the vehicle is traveling on, determining (1354) a location of the vehicle based at least partly on the road surface information, and determining (1356) one or more target illumination areas based at least partly on the location of the vehicle.

### Adas Sensor Range Adaptation

Traditional advanced driver assistance system sensors, which may include LiDAR, radar, or light-based sensors such as cameras, provide sensor readings to a controller which may inform initiation of warnings to a vehicle operator, initiation of autonomous or semi-autonomous driving commands or maneuvers, and/or a combination thereof. These ADAS sensors may have limited mechanisms for calibration, which may lead to sensor errors due to sensor obstruction, a sensor's field of view being incorrect to provide valuable information to the controller, etc.

The inventors have recognized that terrain-based road information and localization may allow adjustment of function of ADAS sensors in a vehicle, such as for example LiDAR, radar, or light-based sensors such as cameras, by, for example accounting for upcoming road obstacles, road events, road contour, etc. If an ADAS sensor has a mechanism for either adjusting its angle in the vertical direction, or its angle in the lateral direction, or both, or has other methods of modifying its optimal functionality, such as for example adjusting its focus range or the amount of background lighting or other parameters, then in a manner similar to that previously described for adaptive headlight control, the optimal sensor parameters may be adjusted based on terrain-based information and the precise location of the vehicle.

For example, in some implementations, a LiDAR sensor may be able to detect objects at a distance and be calibrated for a vehicle on a level road and may have an actuation mechanism for adjusting its lateral and/or vertical directionality and/or sensitivity, or it may have a mechanism for adjusting its range based on internal settings and may be guided to do so. In the presence of a road feature such as a hill cresting or a bowl, the angle may be adjusted pre-emptively to correctly identify the features more relevant for the vehicle. On the other hand, understanding the road contour ahead of the vehicle may also be used to provide information to the operator or driving system that the sensor's detection range is expected to be lower, for example, due to road features ahead of the car, and that thus the vehicle speed or other settings (e.g., autonomous or semi-autonomous driving controller settings) may need to be adjusted.

In some implementations, a range sensor such as a radar may be used to detect the distance to the nearest obstacle ahead of the vehicle and may have a method for adapting its lateral and/or vertical directionality and/or sensitivity and/or range. For example, when travelling around a turn or over a hill crest, a basic sensor may not detect an obstacle in the roadway before the obstacle is directly ahead of the vehicle, since the vehicle direction may not align with the obstacle due to the turn or hill until the vehicle is very close. In this scenario, a terrain-based ADAS system may provide information that the roadway is curved or has vertical elevation change to the sensor system, and the sensor system may adapt its functionality by, for example, moving its range beam or modifying its sensitivity settings.

In some implementations, a vehicle may be travelling along a turn and the range sensor may detect an obstacle that is directly ahead of the vehicle but not along the path the vehicle is travelling, for example by being in an adjacent lane or even in an oncoming traffic lane. In this scenario, the information about the upcoming road direction may be used to avert a false warning from the range system and a proper warning may be provided if the system is able to modify its settings.

In some implementations, an ADAS or range sensor assembly may consist of a plurality of individual sensors or sensor components, and a sensor output, for example a distance to an obstacle, may typically be calculated by using a combination of them with appropriate weighting for each. If a different directionality of sensing is desired, a modified weighting may be applied, for example to prioritize the signal coming from individual sensors or sensor components that detect at an angle that is more toward one side or more upward or downward, depending on the desired effect.

In some implementations, an ADAS or range sensor assembly may have an actuation method that may move a sensor component, such as a light source, a reflector, a lens, or other, and this actuation method may be employed to alter the direction of sensing of the assembly.

It should also be understood that in a situation where the ADAS sensor directionality cannot be modified, either because the sensor lacks the ability to do so, or because of insufficient time or directional range, a warning may be provided to an operator of the vehicle, and/or a modification may be applied to any systems (e.g., autonomous or semi-autonomous driving systems, blind spot warning systems, automatic emergency braking or steering systems, lane keep assist systems, etc.) utilizing the sensor or sensor assembly to take into account that the data provided may not be accurate. As an example, this may prevent an automatic braking system from decelerating a vehicle when a range sensor senses a vehicle in an adjacent lane during a turn on a multi-lane road.

Referring to FIG. 20, a vehicle 1801 is travelling along a roadway with two adjacent travel lanes 1802 and 1803. The roadway follows a curved path ahead of the vehicle 1801. The vehicle 1801 is equipped with a range sensor 1806 that is configured to measure distance from an object straight ahead of the vehicle, following direction 1805, and at a different angle ahead of the vehicle, following direction 1807. A vehicle 1804 is located ahead of vehicle 1801 but in a different travel lane. A traditional range sensor senses vehicle 1804 as an obstacle ahead in the travel path and may engage warnings or actions up to emergency braking. Using a terrain-based ADAS feature configured to precisely predict the curvature of the roadway ahead of the vehicle, and/or the path the vehicle is likely to take based on information from a database including terrain-based information, the system is configured to alert the driver that the sensor reading may be inaccurate, and/or modify the warning settings or actions taken in response to the original sensor along direction 1805. If the sensor system may be configured to modify its sensitivity, range, or directionality, for example to prioritize the signal along direction 1807, then the notion of the curvature of the travel path may be used to select this modified sensor signal as the signal to use for actions related to the range sensor. In the example in the figure, a selection of the sensing signal along direction 1807 would signal that the path that vehicle 1801 is travelling on is not obstructed and would take the appropriate actions for that signal.

Referring to FIG. 21, the flow chart shows a method 1850 for providing terrain-based insights to an adaptive ADAS sensor system of a vehicle. The method includes obtaining (1852) road surface information of a road segment the vehicle is traveling on, determining (1854) a location of the vehicle based at least partly on the road surface information, and determining (1856) one or more target sensing areas based at least partly on the location of the vehicle.

### REAR AXLE STEERING

Advanced driver assistance systems (ADAS) may use onboard sensors to provide steering correction, for example, in the case of lane drift. This steering correction may be suggested to a driver through tactile feedback and/or performed by front steering actuators. However, this feedback may be intrusive or perceived by the driver as an uncomfortable pulling of the vehicle to one side or another. This uncomfortable pulling may cause drive discomfort while operating the vehicle and/or may cause the driver to disable steering correction features of their vehicle's ADAS system.

The inventors have recognized that systems and methods using terrain-based insights described herein may detect lane position and provide unintrusive steering correction using rear steering actuators. Systems and methods described herein may collect driving data from numerous vehicle paths and create an aggregate path (e.g., a path associated with an average of driven paths taken by the numerous vehicles) associated with a road lane. Any appropriate localization method, including those described elsewhere herein, may be used to determine a vehicle path within the lane. If the vehicle path diverges from the aggregate path, the system may create a command for a steering correction system, the steering correction system including one or more rear steering actuators, to influence the travel direction of the vehicle.

Referring to FIG. 22, in scenario 1400, for a given lane 1406 on a road segment 1404 the travel paths 1408, 1410 of a plurality of vehicles traversing the road segment, or by the same vehicle traversing the road segment at different times, may be obtained. These paths may be obtained through global navigation satellite systems (GNSS), inertial navigation, terrain-based navigation, and/or any other localization method or combination of localization methods. If a combination of localization methods is used, individual methods may be enhanced through the use of a Kalman filter, through real-time kinematic (RTK) positioning, and/or through other enhancement means.

After the plurality of travel paths 1408, 1410 are obtained, the plurality of travel paths may be combined to create an aggregate path 1414 that accounts for drivers' preferences of intra-lane positioning (i.e., where laterally within the lane do drivers operate their vehicles at each given longitudinal position along the path). Specifically, such an aggregate path may be created for each lane on a road. In creating the aggregate path 1414, some suboptimal data may be filtered out by, for example, accounting for erratic driving, removing outlier data, or through other filtering means. In one implementation, for example, in the case of a pothole 1420 situated in the lane 1406, an outlier path 1412 that fails to avoid the pothole may not be included in creating the aggregate path 1414.

In some instances, the plurality of travel paths 1408, 1410 may be sent to a cloud database 1416 that may be located on the vehicle, on a different vehicle, or in a remote location. Any filtering performed on the path data may be performed within the cloud after receiving the data. In some instances, the aggregate path 1414 may be stored in the cloud database 1416 and communicated to vehicles on an on-demand basis. For example, a vehicle 1402 driving down the lane 1406 on the road 1404 may send a request to receive the aggregate path 1414 associated with the lane 1406. Such a request may be initiated manually by a driver, or automatically by an ADAS or operating system in the case of a self-driving vehicle. A controller 1418 of the vehicle may initiate that the request be sent to the cloud database 1416.

Referring to FIG. 23, in scenario 1500, once the aggregate path 1414 is created, a travel path 1502 of the vehicle 1402 may then be determined using a localization method capable of ascertaining the vehicle's instantaneous location, speed, and heading. In some implementations, because the travel paths may be indicative of travel within each lane of a road, the localization method may have an accuracy high enough to ascertain in which lane the vehicle is traveling. In some instances, this accuracy may be within 0.3 meters. An enhanced localization method may be used, such as through GNSS combined with RTK positioning, or through other combinations of multiple localization methods such as utilization of inertial navigation or terrain-based navigation in combination with GNSS. In the case of multiple localization methods, data sets may be combined using Kalman filtering to remove statistical noise and other inaccuracies. Other methods of obtaining the preferred accuracy are also contemplated and the disclosure is not so limited.

The travel path 1502 of the vehicle 1402 may then be compared to the aggregate path 1414. In the case where the travel path 1502 diverges from the aggregate path 1414, a corrective signal may be sent to a steering controller 1506, such as a controller for a rear steering actuator, to influence the travel direction of the vehicle 1402 such that the vehicle 1402 will follow a new, corrective path 1504 that approximates the aggregate path 1414. This may allow the vehicle 1402 to correct for lane drift, or to avoid common obstacles such as the pothole 1420, without further input from the driver. The corrective steering controller 1506 may be configured such that corrections to steering are sized to gently prevent deviation from the aggregate path 1414, while also considering the steering inputs coming from the driver or operating system of the vehicle 1402. In this way, the vehicle may maintain the trajectory intended by the operator, for example, in the case of an intentional lane change or shift to avoid objects in the road.

In some instances, the vehicle 1402 may include a localization system capable of locating the vehicle to a high degree of accuracy, for example, within 0.3 meters. In some instances, the vehicle 1402 may include at least one system capable of influencing the direction of vehicle travel. Such a system may be a steering system, a suspension system, or a rear steering actuator. Other systems may also be appropriate, and the disclosure is not so limited. In some instances, the vehicle 1402 may include a controller 1418 capable of receiving data from a cloud system and from the localization system. The controller 1418 may be capable of comparing the data received from both systems to generate a command that is then sent to the system capable of influencing the direction of vehicle travel.

Referring to FIG. 24, a method 1600 of providing corrective steering is shown in a flowchart 1600. The method includes obtaining (1602) using a high-accuracy localization system (e.g., terrain-based localization) to gather travel paths of at least two vehicles, or of at least two traversals by the same vehicle. In some instances, the travel paths may be created using instantaneous location data, speed data, and heading data. The method also includes generating (1604), using the at least two travel paths, a first system travel path (also called an aggregate path) representative of an operators' preferred path in one lane on a road. In some instances, the aggregate path may be generated using a data set filtered to remove outliers or non-optimal travel paths. Such non-optimal travel paths may represent erratic drivers, paths obtained at abnormal speeds, paths obtained from vehicles not in a similar vehicle class, or paths obtained during high-traffic conditions, as well as paths that are considered mathematical outliers based on their data compared to the remaining paths, for example by using a clustering method on the set of paths. The method also includes obtaining (1606) a second travel path of a vehicle (the current path that the vehicle is taking while traversing the road segment), for which corrective steering is desired, using high-accuracy localization. In some instances, the high-accuracy localization method employed may have an accuracy within 0.3 meters. The method also includes comparing (1608) the travel path of the operated vehicle to the aggregate path, and based on this comparison, generating (1610) a command to correct the travel path of the driven vehicle. The method also includes sending (1612) the command to a corrective steering controller. In some instances, the controller may be configured to initiate steering commands to control a rear steering actuator.

In some implementations, the information regarding the position of the vehicle versus the average travel lane may also be used to determine the state of the operator themselves. If the operator is a human driver, a deviation from the preferred path that is repeated and/or has certain characteristics may be used to diagnose the driver's state. For example, a deviation from the average travel lane characterized by long periods of drift, for example 5 sec long, or 1 sec long, with abrupt corrections, may be an indication of the driver not being fully alert, distracted, in an impaired state due to drugs or alcohol, or falling asleep. If the operator is a machine (e.g., an autonomous or semi-autonomous driving system), then a deviation from the path may be used to diagnose sensor and/or actuator functions, calibrations, and offsets. For example, a constant offset to one side may be an indication of a camera malfunction or calibration error in systems using a camera as the primary feedback sensor for lane keeping.

### System and Method for Avoiding Obscured Road-surface Features

Road surface features, road anomalies, or road events, which may include without limitation, a pothole, a bump, a road-surface crack, an expansion joint, a frost heave, etc., may be obscured to a driver of a vehicle due to poor lighting, weather conditions (e.g., fog, heavy rain, snow, etc.), and/or other vehicles. This obscuring of road surface features may cause a driver to operate the vehicle in a manner that is suboptimal for interacting with the road surface feature (e.g., driving too fast) or may cause a driver to miss an opportunity to navigate the vehicle around the road surface feature. Such suboptimal vehicle operation may cause discomfort, vehicular damage (e.g., to tires, chassis components, etc.), and/or may be less safe than optimal operation.

The inventors have recognized that road surface information may be used to help drivers avoid various road surface features or anomalies and/or minimize their impact on a vehicle when and if there is an interaction with a road surface feature or anomaly. Road surface features or anomalies may include, without limitation, a pothole, a bump, a road-surface crack, an expansion joint, or a frost heave. Location of an anomaly or road-surface feature may be determined by, for example, terrain-based localization systems. However, the inventors have recognized that once the relative location of a road-surface feature or anomaly is available to an on-board controller, a heads-up display may be used to display the feature or anomaly and its position relative to the vehicle, even if the feature or anomaly may be obscured or concealed by poor lighting, weather conditions (e.g., fog), and/or other vehicles.

The inventors have also recognized that once the relative location of a road-surface feature or anomaly is available to an on-board controller, a monitor may be used to display the feature or anomaly and its position relative to the vehicle instead of or in addition to using a heads-up display.

FIG. 25 illustrates a vehicle travelling in lane 1702. Vehicles 1704 and 1706 are travelling ahead of vehicle 1700 in lanes 1702 and 1708, respectively. Under the conditions illustrated in FIG. 25, a controller (not shown) on board vehicle 1702 may be aware that there is a pothole ahead in lane 1702. However, the pothole may be obscured by vehicle 1704. The controller may further be aware of the size of the pothole and that it may be avoided by straddling it with the wheels of vehicle 1700. FIG. 25 illustrates a heads-up display that shows: image 1706a of vehicle 1706, image 1704a of vehicle 1704, images 1712a and 1714a of lane markers 1712 and 1714 respectively. Additionally, the heads-up display also displays the image of pothole 1716 and its relative position to the prospective path of the left and right tires 1720 and 1721, respectively, of vehicle 1700, if the existing steering angle is maintained. If the steering angle is altered, the heads-up display 1710 may be adjusted to show the new tire paths relative to pothole 1716.

With this data a driver may be able to adjust the steering angle of vehicle 1700 to avoid the anomaly and/or road feature. With advance notice, the driver may avoid the pothole, or any road surface feature, by taking evasive measures without having to wait until the feature is visible.

It is noted that under certain conditions such as, for example, heavy fog, vehicles 1706 and/or 1704 may also be obscured. In some implementations, sensors such as radar detectors may be used to locate the vehicles and display their image(s) in the heads-up display even if the vehicles themselves are not visible to the naked eye.

Referring to FIG. 26, the flow chart shows a method (1900) executed by a vehicle including a localization system configured to determine a location of the vehicle, a display, and a processor configured to perform the steps of: obtaining (1902) a location of the vehicle from the localization system (the steps of such localization have been previously discussed in relation to FIG. 1 and implementations of other terrain-based insights); determining (1904) the presence of one or more road surface features on a road surface based at least in part on the location of the vehicle; and presenting (1906) on the display a position of the one or more road surface features on the road surface.

The above-described embodiments of the technology described herein may be implemented in any of numerous ways. For example, the embodiments may be implemented using hardware, software or a combination thereof. When implemented in software, the software code may be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format. It should also be understood that any reference to a controller in the current disclosure may be understood to reference the use of one or more processors configured to implement the one or more methods disclosed herein.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices may be used, among other things, to present a user interface. Examples of output devices that may be used to provide a user interface include display screens for visual presentation of output and speakers or other sound generating devices for audible presentation of output. Examples of input devices that may be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. These methods may be embodied as processor executable instructions stored on associated non-transitory computer readable media that when executed by the one or more processors perform any of the methods disclosed herein. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media may be transportable, such that the program or programs stored thereon may be loaded onto one or more different computing devices or other processors to implement various aspects of the present disclosure as discussed above. As used herein, the term “computer-readable storage medium” encompasses only a non-transitory computer-readable medium that may be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that may be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1-37. (canceled)

38. A method for providing terrain-based insights to an automatic emergency braking system of a vehicle, the method comprising:
obtaining a road profile of a road segment the vehicle is traveling on;
determining a location of the vehicle based at least partly on the road profile; and
determining one or more automatic emergency braking trigger point distances at least partly on the location of the vehicle.

39. The method of claim 38, further comprising transmitting the one or more automatic emergency braking trigger point distances to the vehicle.

40. The method of claim 39, further comprising operating the automatic emergency braking system based at least partly on the one or more transmitted automatic emergency braking trigger point distances.

41. A method for determining an automatic emergency braking trigger point distance for a vehicle, the method comprising:
obtaining, by one or more sensors of the vehicle, road data of a road segment on which the vehicle is traveling;
determining, based on the road data, a current road profile of the road segment;
sending, to a cloud database, the current road profile;
receiving, from the cloud database, a set of candidate stored road profiles;
determining, by a processor, a location of the vehicle based on the set of candidate stored road profiles and the current road profile;
determining, by the processor, the automatic emergency braking trigger point distance, the automatic emergency braking trigger point distance being based, at least partially, on the location of the vehicle; and
initiating, when the vehicle is within the automatic emergency braking trigger point distance from another vehicle or object, via an advanced driver assistance system of the vehicle, an alert to a driver to brake.

42. The method of claim 41, further comprising, initiating, when the vehicle is within the automatic emergency braking trigger point distance, via an advanced driver assistance system of the vehicle, a braking command configured to initiate braking of the vehicle.

43. The method of claim 41, further comprising, initiating, when the vehicle is within a second distance, smaller than the automatic emergency braking trigger point distance, via an advanced driver assistance system of the vehicle, a braking command configured to initiate braking of the vehicle.

44. The method of claim 41, wherein the alert comprises at least one of a visual alert, an audio alert, or a tactile alert.

45. The method of claim 44, wherein the alert is a visual alert and is presented on a display in the vehicle.

46. The method of claim 45, wherein the automatic emergency braking trigger point distance is based, at least partially, on road information for an upcoming portion of the road segment on which the vehicle is traveling.

47. The method of claim 46, wherein road information for an upcoming portion of the road segment comprises weather information.

48. The method of claim 46, wherein road information for an upcoming portion of the road segment comprises road profile information.

49. The method of claim 48, wherein the road profile information comprises at least one of road slope information, road roughness information, road frequency content, road friction information, road curvature, or road grip information.

50. The method of claim 46, wherein road information for an upcoming portion of the road segment comprises road event information.

51. The method of claim 50, wherein road event information comprises a location of at least one of a pothole or a speedbump.

52. The method of claim 50, wherein the road event information is based on road data that has been normalized by vehicle class.

53. The method of claim 46, wherein road information for an upcoming portion of the road segment comprises road feature information, wherein the road feature is a bridge.

54.-120. (canceled)
